(19) United States
(12) Patent Application Publication
(10) Pub. No.: US 2010/0057556 A1
(43) Pub. Date: Mar. 4, 2010

(54) Apparatuses, Methods And Systems To Identify, Generate, And Aggregate Qualified Sales and Marketing Leads For Distribution Via an Online Competitive Bidding System

(76) Inventors: Armand Rousso, New York, NY (US); Jane Linder, Brooklyn, NY (US); Stuart Kauder, New York, NY (US); Schwartz Steven, New York, NY (US)

Correspondence Address: CHADBOURNE & PARKE LLP, 30 ROCKEFELLER PLAZA, NEW YORK, NY, 10112, US

(21) Appl. No.: 11/911,474

(22) PCT Filed: Apr. 12, 2006
(86) PCT No.: PCT/US06/13873

§ 371 Date: Mar. 6, 2009

Related U.S. Application Data
(60) Provisional application No. 60/670,747, filed on Apr. 12, 2005.
(60) Provisional application No. 60/763,204, filed on Jan. 27, 2006.

(51) Int. Cl. G06Q 30/00; G06Q 10/00

(52) U.S. Cl. 705/14.44; 705/14.71; 705/14.54

(57) ABSTRACT

The disclosure details the implementation of an apparatuses, methods, and systems to identify aggregate and generate bids for online sales leads. A lead facilitator may use an online lead bidding system to aggregate, and focus user leads and make them available to providers. The providers may make bids to acquire leads from users that are specific to the provider's goods and/or services. The winning bidders are then allowed to provide advertising, offers, and/or the like to the lead generators. Also, the winning bidders are provided with information submitted by the lead generators for follow-up contact, which may include: personal face-to-face meetings, telephone calls, emails, Web links (e.g., for purchasing an item), and/or the like. The lead bidding system also allows for the creation of numerous categories and campaigns, which are useful for market research as well as sales lead generation. As such, the lead bidding system efficiently facilitates commerce by providing qualified leads to providers of goods and services.

### RELATED APPLICATIONS

Applicant hereby claim priority under 35 USC §119 for U.S. provisional patent application Ser. No. 60/670,747, filed Apr. 12, 2005, entitled “APPARATUSES, METHODS AND SYSTEMS TO IDENTIFY, GENERATE, AND AGGREGATE QUALIFIED SALES AND MARKETING LEADS FOR DISTRIBUTION VIA AN ONLINE COMPETITIVE BIDDING SYSTEM.”

Applicant hereby claim priority under 35 USC §119 for U.S. provisional patent application Ser. No. 60/763,204, filed Jan. 27, 2006, entitled “APPARATUSES, METHODS AND SYSTEMS TO IDENTIFY, GENERATE, AND AGGREGATE QUALIFIED SALES AND MARKETING LEADS FOR DISTRIBUTION VIA AN ONLINE COMPETITIVE BIDDING SYSTEM.”

This application also hereby incorporates by reference the application for letters patent, Ser. No. 10/946,488, entitled “APPARATUS, METHOD AND SYSTEM OF ARTIFICIAL INTELLIGENCE FOR DATA SEARCHING APPLICATIONS,” and filed in the United States Patent and Trademark Office on Sep. 21, 2004.

The entire contents of the aforementioned applications are herein expressly incorporated by reference.

### FIELD

The present invention is directed generally to an apparatuses, methods, and systems of commerce, and more particularly, to apparatuses, methods and systems to identify aggregate and generate qualified sales and marketing leads for distribution via an online bidding system.

### BACKGROUND

Current online advertising techniques, such as Internet search engine paid inclusion and paid placement, along with contextual network advertising and publishing, allow advertisers to promote targeted solicitations for offers and control advertising budgets. As such, current online advertising techniques help users locate such solicitations for offers of goods and services. For example, a successful pay-per-click advertisement within a search engine results page (e.g., “Cell Phone & Plans”) will direct traffic to an existing web site (e.g., wireless carrier) solicitation. Current online techniques for obtaining leads are limited to a specific, set and static company soliciting inquiries for a specific, set and static product on a one-off basis within specific vertical industries (e.g., lending, insurance).

### SUMMARY

The prior techniques do not allow diverse, unaffiliated, sales and marketing organizations and advertisers to access a single pool of sales and marketing leads across industry verticals. As such, this disclosure details an online lead bidding system (“lead bidding system”) that delivers a dynamic lead generation platform for all advertisers to participate in ongoing competitive bidding for qualified online leads. In one embodiment, the lead bidding system allows the most interested providers of articles of commerce to capture leads to interested consumers; for example, such leads may be captured through a search facility. The lead bidding system grants the advertiser a mechanism for acquiring qualified and validated leads, and may concurrently guard against inherent methods of abuse found in the pay-for-click model. The lead bidding system allows for the creation of countless categories, lead types, and lead attributes, opening up the field of advertisers beyond traditional lead generation verticals, even to those who do not maintain existing online channels (e.g., a local landscaping service company, a custom cars hobbyist who makes occasional sales).

From the Web user point of view, the lead bidding system provides a means by which, in exchange for relevant lead generation information, he/she can receive one or more solicitations for offers from sales and marketing organizations and advertisers with relevant solicitations for offers in which they are interested.

In one embodiment, the lead bidding system provides a survey management system that allows for on-the-fly survey creation.

Advertisers participate in an ongoing competitive bidding system that combines user parameters with those of the advertiser bids, resulting in winning bidders. The winning bidders are then allowed to contact leads with relevant offers of goods and services. Also, the winning bidders are provided with information submitted by the leads for follow-up contact, which may include: telephone calls, emails, text messages, Web links (e.g., for purchasing an item), and/or the like. The lead bidding system also allows for the creation of campaigns, which are useful for market research as well as sales lead generation. Campaign and category systems grouping supports lead bidding system in syndication efforts, such as affiliate marketing programs. As such, the lead bidding system efficiently facilitates commerce by providing qualified leads to advertisers of goods and services.

### BRIEF DESCRIPTION OF THE DRAWINGS

The accompanying appendices and/or drawings illustrate various non-limiting, example, inventive aspects in accordance with the present disclosure:

FIGS. 1-3 are of data-flow block diagrams illustrating overviews of a Lead Bidding System (LBS);

FIG. 4 is of a block diagram illustrating a functional options that are provided to users of the Lead Bidding System;

FIG. 5 is of a logic-flow diagram illustrating a consumer interface for the LBS;

FIG. 6 is of a logic-flow diagram illustrating a consumer experience for the LBS;

FIG. 7 is of a block diagram illustrating a lead data form. The lead data form may be presented in many different formats;

FIG. 8 is of a logic-flow diagram illustrating a lead verification facility;

FIG. 9 is of a block and logic-flow diagram illustrating a search facility;

FIG. 10 is of a logic-flow diagram illustrating an advertiser administration facility;

FIG. 11 is of a logic-flow diagram illustrating qualified lead listing creation;

FIG. 12 is of a block diagram illustrating the user interface for qualified lead listing creation;

FIG. 13 is of a logic-flow diagram illustrating qualified lead listing creation and modification requests;

FIG. 14 is of a block diagram illustrating an interface for an advertiser administration facility;

FIG. 15 is of a data-flow block diagram illustrating a basic overview of a administration facility;

FIG. 16 is of a data-flow block diagram illustrating lead type management;

FIG. 17 is of a data-flow block diagram illustrating keyword management;

FIG. 18 is of a data-flow block diagram illustrating qualified lead list and user management;

FIG. 19 is of a logic-flow diagram illustrating a bid and billing facility;

FIG. 20 is of a logic-flow diagram illustrating a bidder participation determination;

FIG. 21 is of a logic-flow diagram illustrating a bidder determination;

FIG. 22 is of a block diagram illustrating embodiments of the present invention of an lead bidding system controller;

FIG. 23 is of a block diagram illustrating an alternative embodiment of the lead bidding system component;

APPENDICES 1-13 detail the lead bidding system's database structure.

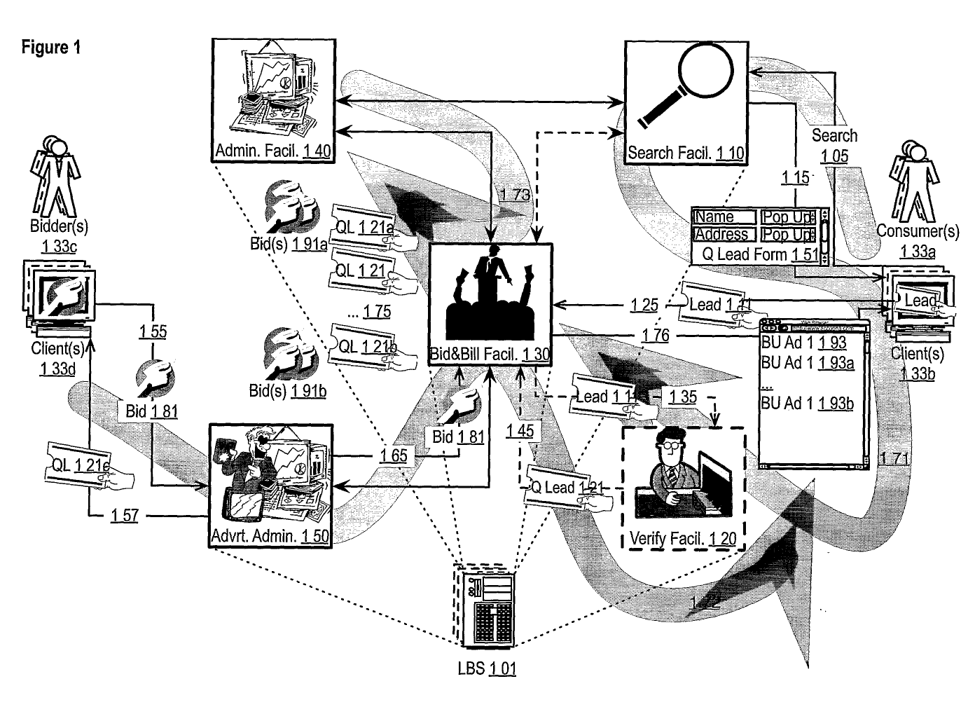

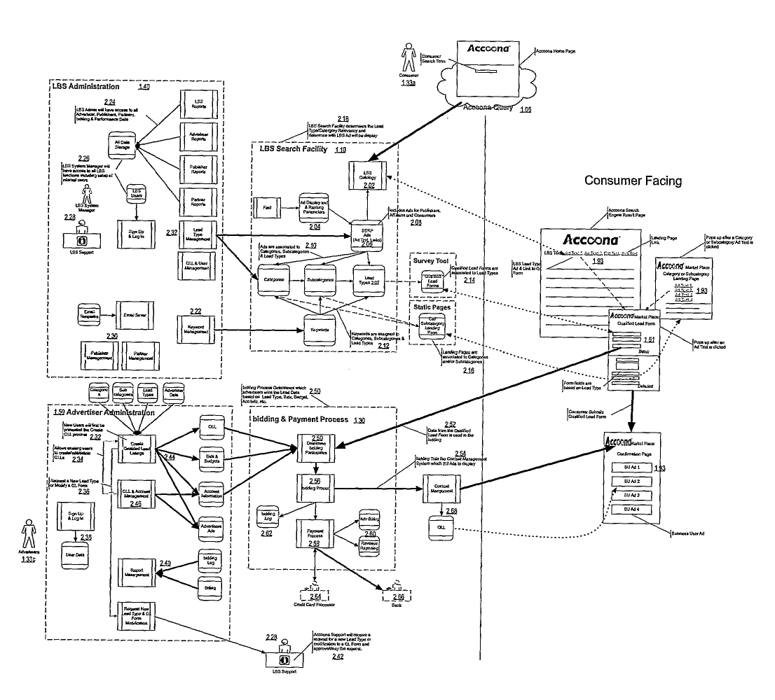

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

FIGS. 1-3 are of data-flow block diagrams illustrating overviews of a Lead Bidding System. The disclosed Lead Bidding System (LBS) involves three basic actors: i) consumers 133a, ii) the lead bidding system 101, and iii) bidders (i.e., advertisers, business users, providers, sellers, partners, and/or the like) 133c. In addition to the three basic actors, the LBS enables the creation of two types of transactional articles: i) leads and ii) bids 191 on the leads. The LBS takes bids on consumer leads and allows the winning bidder to advertise to the consumers. The LBS generates leads by converting evinced consumer information, interest and responses into leads. As such, leads are transactional articles that act as a catalyst to heighten a provider's opportunity and increase the provider's likelihood of consummating a transaction with the consumer. In turn, the leads are bid upon by providers (i.e., bidders). The winner of the bidding for the lead then receives delivery of the lead data and is afforded the opportunity of placing targeted advertisements (e.g., ads related to the generated lead) before the lead generating consumer.

In one embodiment, the lead bidding system provides a search interface to the consumers, which allows them to locate various goods and/or services. Consumers may enter searches, traverse categories of goods and services, target searches to specific categories, obtain random prompts for categories and/or goods or services, and/or the like. As part of their searches, the users may be prompted to provide some information to identify themselves. For example, the consumers may provide their email address along with various criteria regarding their search (e.g., search terms, responses to web form queries, etc.); such information may form the basis of consumer profiles that may be saved by the lead bidding system. As these searches and responses are indicative of interest in various goods and services, in one embodiment, such consumer searches may constitute leads to the providers of goods and services. Such leads are valuable to the providers because the consumers are showing an interest to procure the target goods and/or services. As such, the leads represent a heightened opportunity to consummate a transaction.

As the first online advertising platform and central marketplace for lead generation, the LBS is designed to originate and deliver real-time, authenticated, qualified leads to all types of providers of goods and services. The LBS moves beyond the pay-per-click model; it provides advertisers and providers with greater accountability for a positive return on investment (e.g., by securing permissions-based information from proactive and qualified seekers of goods and services designed to increase close rate on sales). In one embodiment, LBS is designed to allow advertisers to obtain better rates of acquisitions of prospective consumers. This allows In one embodiment the LBS determines pricing through market competition, yielding the maximum return per lead. In one embodiment, a self-service platform enables the development of a dynamic network of buyers and sellers, across local and global markets. In another embodiment, the LBS provides consumer brand experience and may act as the internet's definitive comparison offer marketplace combining the best of online comparison offers, yellow pages, and search marketing.

In one embodiment, the LBS may provide the following benefits to consumers, advertisers, publishers and search partners:

Consumer and business-to-business benefits include: relevant and targeted advertising; comparison offers model value proposition (i.e., saving time and money); one form and up to four offers from competing providers; offers for all types of goods and services; and/or the like. Advertiser benefits include: freshly originated, qualified and verified leads; bonus display ad on confirmation page; performance-based pricing via bidding system; dynamic offering of lead types and filters across all vertical markets and target demographic areas; self-service tools for lead type and account management and reporting; and/or the like. In one embodiment, publisher benefits include: relevant advertising via contextual advertising; minimal ad space required for best advertising return on investment; complementary to existing text and display ads, e.g., one line of text; up to four times the revenue share of average CPA advertising. In another embodiment, the LBS works as a better ad model for certain categories of goods and services where it allows advertisers to better focus the costs per prospective consumer on more interested targets. Search partner benefits include: relevant advertising via search; minimal ad space required for best advertising return on investment; complementary to existing text and display ads, e.g., one line of text; up to four times the revenue share of average CPA advertising.

### Lead Bidding System Basic Overview

FIG. 1 is of a data-flow block diagram illustrating a basic overview of a Lead Bidding System. In one embodiment, the LBS 101 facilitates interaction between bidders/providers 133c and consumers 133a as to the ads the consumers will see 193 in the course of a search for goods and services. In such an embodiment, the LBS may be viewed as having five components: i) a search facility 110, ii) a bid and billing facility 130, iii) an optional verification facility 120, iv) an administration facility 140, and v) and an advertiser administration facility 150. Also, in such an embodiment, the LBS can be seen to facilitate three distinct currents of transactions (i.e., the large light grey arrows): i) lead generation currents 171, ii) lead bidding and advertising currents 172, and iii) administrative lead structure currents. Although each of the LBS' five components, three actors, and two transactional articles will be discussed in greater detail throughout this disclosure, an overview of the LBS can be observed by following the flows of its transactional currents.

Lead Generation Current

With regard to the lead generation current 171, consumers 133a may engage in a search for goods, services, and/or other random search criteria via client computers 133b (e.g., via personal computer running a web browser such as Mozilla's Firefox). The consumers may engage in searches via an online search engine such as Accoona's web search facility Acoona.com (Accoona).

The consumers provide search requests 105 to the search facility 110, which will provide the consumer with search results 115. As was already mentioned, the consumers search may initiate the generation of a lead. As part of the search results, the consumer may be presented with ads, and eventually may be contacted by providers that bid on the consumer's lead. Also, as part of the search results, the consumers may be presented with a qualified lead form 151 into which consumers may enter identifying information. This information may be saved as part of a consumer profile at the client 133b, the search facility 110, at a verification facility 120, the bid and billing facility 130, and/or the like. The user does not necessarily have to fill out a qualified lead form 151, but may provide responses indicative of their interest in a particular kind of good or service (e.g., providing a search for a type of product, clicking on search results indicative of that type of product, etc.). By searching, filling out the qualified lead form 151 and/or providing responses indicative of interest in goods and/or services of a certain type, the consumer is generating a lead 111.

The lead 111 may then be provided to a bid and bill facility 130. In one embodiment, the client 133b provides the lead directly to the bid and bill facility 130. In another embodiment, the search facility 110 may provide leads to the bid and bill facility. In yet another embodiment, part of the lead may be obtained directly from the consumer, while another part will be received from the search facility. The bid and bill facility 130 may then provide 135 the lead 111 to a verification facility 120, which can verify and/or qualify the lead and provide a rating on the lead as to the quality of the lead. As such, the verification facility 120 may then provide 145 a qualified lead 121 back to the bid and bill facility 130. In an alternative embodiment, the client 133b may provide a lead directly to the verification facility 120, which would then qualify the lead 121 and provide it to the bid and bill facility 130. In such a manner, currents 171 of qualified leads would be generated and provided by consumers to the bid and bill facility 130.

Lead Bidding and Advertising Current

With regard to the lead bidding and advertising currents 172, bidders 133b may engage in a search for consumers of goods and/or services via client computers 133d. As the bidders may be purveyors of goods and/or service, they are interested in finding leads to consumers that are interested in the types of goods that they provide. The bidders 13c may use the advertiser administration facility 150 through their client computers 133d to specify the categories, types of leads and lead segments (e.g., by qualifications/questions, by demographics, by region, by data level/number of questions, etc.) they are interested in, and in turn, to provide 155 bids 181 for the specified types of leads. In addition, the bidders may supply 155 advertisements to the advertiser administration facility 150, which may be used should they have winning bids on leads.

The bids 181 are provided 165 to the bid and bill facility 130. In an alternative embodiment, the client's computer 133d provides the bids 181 directly to the bid and bill facility 130. The bid and bill facility 130 aggregates bids 191. As the bid and bill facility 130 receives currents of leads 111 and/or qualified leads 121, it matches aggregated bids 191a to the qualified leads 121a. It should be noted that the in an alternative embodiment qualified leads may be comprised of leads that have been verified by the verification facility 120 and/or leads that have not 111. However, in such an embodiment, the bid and bill facility 130 will qualify either a verified 121 and/or non-verified lead 111 as being of a certain type and/or belonging to a certain category of goods, services, and/or the like. By qualifying the leads 175, the bid and bill facility 130 may match 175 qualified leads of a given type and/or category to bids 191 of a matching and/or similar type and/or category.

As such, the bid and bill facility may employ a large number of heuristics in choosing which bid and/or bids 191a will win the right to exploit a matching qualified leads 121a. For example, in one embodiment, only a single bidder will win the exclusive right to exploit a single lead. In another embodiment, a limited number of bidders will be allowed to exploit a given lead. In yet another embodiment, and unlimited number of bidders will be allowed to exploit a given lead. In the limited and/or unlimited cases, the higher bidders would enjoy increased access to the lead (e.g., chat/push to talk voice access to such lead, allowing the placement of ads with greater frequency and/or prominence before the lead generating consumer, and/or the like).

In one embodiment, confirmation of bid success and/or billing information would be provided by the bid and billing facility 130 back to the bidder 133c; this may be done directly from the bid and bill facility 130 or via 157 the advertiser administration facility 150 (e.g., when the bidders view their account status, via email, via invoice, etc.). Once a bidder wins a bid for a lead, the bid and bill facility 130 may provide 176 an advertisement 193 to the client computer 133b in response to the client's search 105. The bid and bill may also supply winning bidders with the consumers qualified lead 121c. In an alternative embodiment, the bid and bill facility 130 may instruct the search facility 110 to provide the ads from the winning bidder as part of the consumer's search results. In another embodiment, the bid and bill facility 130 may provide the lead to the winning bidder(s), and the winning bidder(s) may contact the consumer via alternative avenues (e.g., via chat screen, direct mailing, email, facsimile, in person, instant messenger message, telephone, etc.). In such a manner, currents 172 of bids 121 and advertising 193 flow between bidders 133c, the bid and billing facility 130, and consumers 133a.

Administrative Lead Structure Current

With regard to the administrative lead structure current 173, administrators of the LBS may engage in creating categories and/or campaigns of various types that may be used to configure the bid and billing facility 130 to categorize and/or match various bids 191 and leads 121 to one another.

### Detailed Overview of Lead Bidding System

FIG. 2 is of a block diagram illustrating a more detailed overview of the Lead Bidding System. FIG. 2 provides greater detail of various processes and/or sub-components that may comprise the various components of the LBS 110, 120, 130, 140. As already mentioned in FIG. 1, a consumer 133a may initiate a search 105 that will be provided to a search facility 110. In so doing, in one embodiment, the search facility 110 may determine the search lead's type/category, relevancy and what ad should be displayed as part of the search results 218. This may be achieved as various keywords are assigned to categories, subcategories, lead types, and/or the like (type tags) 212. Each of these keywords may be stored as part of an LBS search database with associations to various category/type data tables 212. Further, ads, similarly, may be associated categories, subcategories, lead types, and/or the like 210. As both keywords and ads are type tagged, in response to type tagged keywords, relevant ads whose type tags match the keywords' type tags may be provided as part of search results. As such, various ad display and ranking parameters 204 may be used to serve ads for providers 208 on search engine results pages (SERPs). Furthermore, the various leads and/or search keywords may be used to establish and or make matches based on an ontology 202; the search facility may be of the type discussed in U.S. patent application Ser. No. 10/946,488, entitled “APPARATUS, METHOD AND SYSTEM OF ARTIFICIAL INTELLIGENCE FOR DATA SEARCHING APPLICATIONS,” which is hereby incorporated by reference. Additionally, with the use of a survey tool, these type tags may also be used to tag qualified lead forms 151 with associated lead types 214. Static pages may be tagged with associated categories and/or subcategories 215.

These keyword tag types may be established through the administration facility's 140 keyword management component 220. Similarly, the general types of categories and ads types may be established through a lead type management component 232. The administration facility stores data and reports for bidders, bid sales and performance data 224. As such, various management and/or support personnel 228 will have the ability manage the system (e.g., setting up users) 226. Similarly, the managing users 228 will be able to manage email and various publisher and partner branded versions of the LBS 230.

The bidders 133c may interact with the LBS through the advertiser administration facility 150. Once a bidder has established an account, their user information is stored in the LBS database 238. New bidders are presented with the ability to create qualified lead listings 232; they will be able to specify the various categories, subcategories, lead types, lead type segments, regions, number of questions, advertiser data, and/or the like. In so doing, the obtain the various qualified lead listing (QLLs), bids, budgets, account information, ads, and/or the like 244 from the bidder. After creating the QLL, users may manage existing accounts and QLL information through an account management component 246. In addition, bidders may request new lead types, categories, modify a qualified lead form, and/or the like 236; in making such a request, LBS support 228 may augment categories and/or forms as requested 242. In an alternative embodiment, bidders are allowed access to the lead type 232 and keyword management 222 components of the administration facility 140 and may modify the forms and/or tag types themselves.

The bid and billing facility 130 determines which bidders win the qualified lead based on lead type, lead segments, regions, data levels, bid values, campaign budgets, account information, and/or the like 250. It should be noted that there are multiple ways that LBS determines winners, e.g., the advertiser's feedback rating and other rating/ranking criteria may be used. The bid and billing facility 130 will use qualified leads (e.g., information from qualified lead forms 151) 252 as part of its bid award heuristic 256. Upon determining winning bids 256, the heuristic component 256 may inform the lead delivery component to transfer said lead to the winning bidder, or it may also inform the content management component 268 of which ads to provide for placement on the consumer's web page 193. In so, the selected bid is logged 262 and a payment component 258 will report revenues and obtain billing rates 260 from the LBS database. The charges for the bidder may be processed via credit card 264, bank transaction 266, and/or the like. In this embodiment, no verification facility 120 is shown.

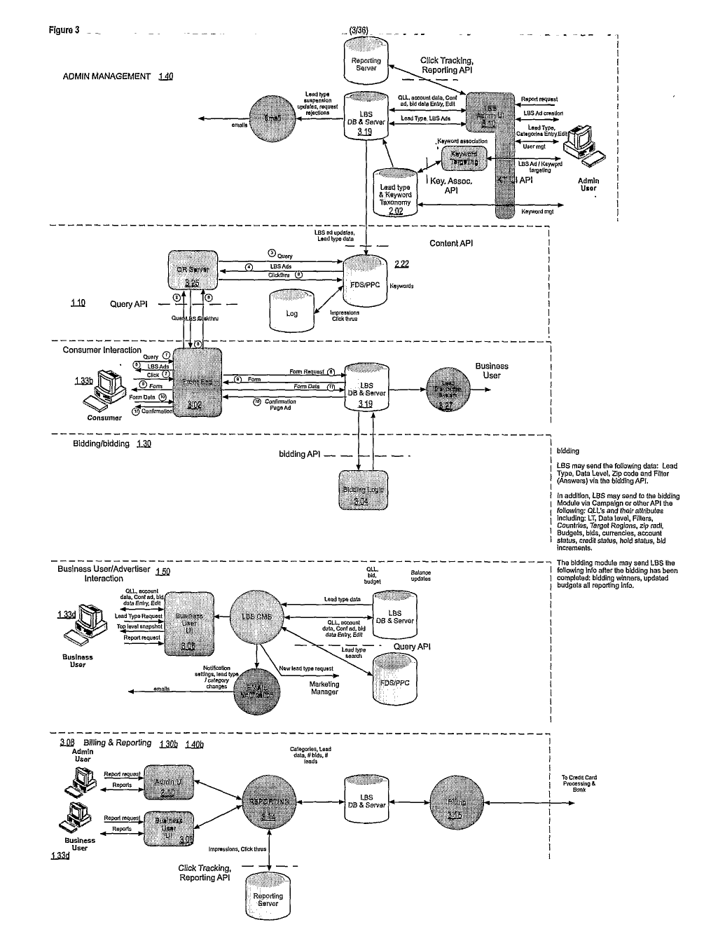

FIG. 3 is of a block flow diagram illustrating a more detailed overview of the Lead Bidding System. FIG. 3 also shows one embodiment with greater transactional detail of the various LBS components. In this embodiment, the LBS may be constructed with the following components: a) a self-service web-base system to facilitate the lead type selection process, account setup and reporting mechanism for bidders 306, 314; b) an LBS search system to facilitate the return of relevant LBS ads based on user entered search terms 110; c) a bidding system to allow business users to bid on and purchase leads supplied by consumers 130; d) a lead data verification system to verify consumer's data 120; e) an ad serving component to facilitate serving and monitoring of LBS ads within search engines (e.g., Accoona.com) and other search verticals 302, 325, 319; f) an ad serving component to facilitate serving and monitoring LBS ads within external websites based on keyword actuation and/or contextually (e.g., from page text linguistic analysis) 302, 319, 327; g) a web-based administrative system to facilitate the creation, editing, deleting and reporting of LBS ads and their attributes 150; h) a web-based administrative system to facilitate the creation, editing, deleting and reporting of lead types and their attributes 140; i) a web-based administration system for monitoring and controlling all aspects of users accounts including account setup, billing and reporting 140; j) a web-based taxonomy administration system to support keyword term mapping to lead types, category and subcategory landings 202; k) an automated billing system 308, 315. As can be seen, these functional components may be distributed and/or consolidated depending on deployment requirements.

Here, the consumer 133b may be seen interacting with a front end 302 that is connected to the search component 110 and the bid and billing component 130. The search component 110 may have its keywords and tag types augmented 222 through the administration facility 140. Once qualified leads have been provided by the consumer 133b, the bid and billing facility's 130 heuristic component 304 will be employed to select winning bids, and as a consequence, leads will be delivered to the bid winners, and/or advertisements may be displayed to the consumer 133b. The bidders 133d may interact with the LBS via the advertiser administration facility's 150 business user interface 306.

However, in this embodiment, billing and reporting may be viewed as its own component 308. In this embodiment, the administration facility's 140 user interface component 310 may be used by administrative users while business users 133d may use the advertiser administration facility's 150 user interface component 306. Each of the user interfaces may connect to the LBS' reporting component 314.

Component Interface Options

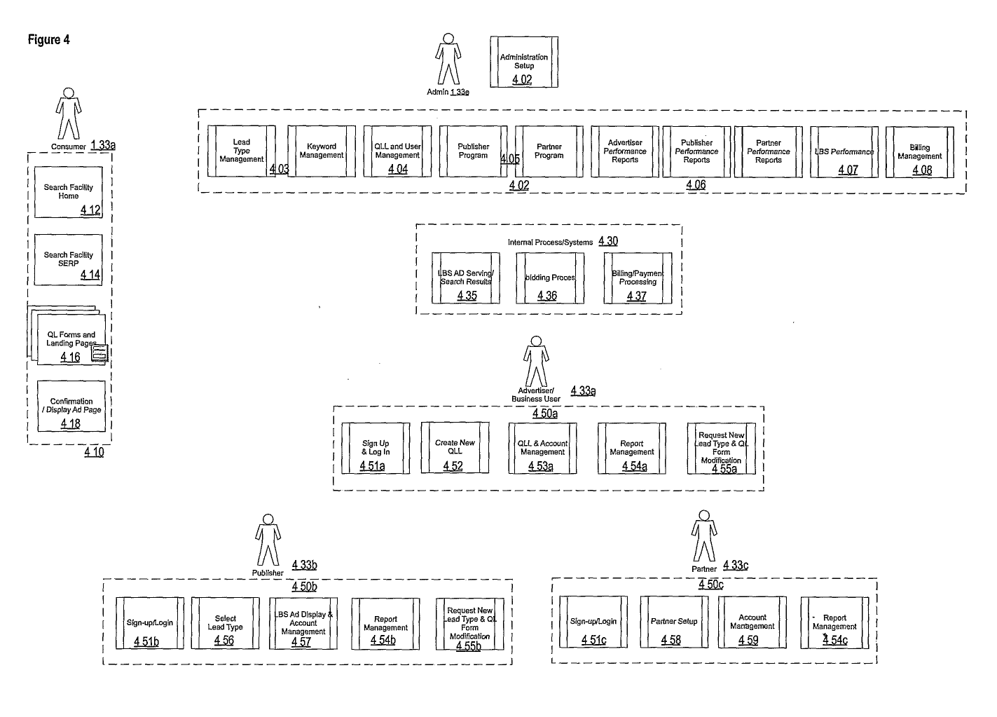

FIG. 4 is of a block diagram illustrating a functional options that are provided to users of the Lead Bidding System. Each of the components have various interfaces that are presented to users. In general, the LBS may be seen as having three types of users: i) consumers 133a, bidders 133b and LBS administrative users 133e. As previously mentioned, bidders 133b may come in a number of varieties, and the LBS may be tailored to the needs of the various business user types that might engage in bidding for leads. In one embodiment, the LBS is configured to the needs of advertisers and business users 433a, publishers 433b and partners 433c. As can be seen, the LBS provides specific and tailored user options to each type of user.

The administrative user 133a interface 402, generally, provides the user with: interfaces to manage, edit, create, etc. lead keywords and types 403; establish qualified lead listing campaigns and manage users 404; administer, create, edit, etc. publisher and partner programs 405; generate various reports (e.g., advertiser, publisher, partner performance reports) 406; evaluate overall LBS performance (e.g., by examining and performing statistical analysis on the systems reporting logs) 407; and manage billing 408.

The consumer 133a interface 410, generally, provides the user with: a search facility 110 home page 412, into which the user may supply search requests; search engine results pages 414, in response to searches; qualified lead forms 151 and landing pages 416, for obtaining additional information regarding the consumer's area of interest; and, confirmation and ad display pages 418.

The advertiser administration facility interface 450a for advertiser/business users 433a, generally, provides the user with: a sign up and/or login page 451a; the ability to create qualified lead listings (QLLs) 452; the ability to manage QLLs and their accounts 453a; general report management regarding their accounts and/or activities 454a; and a facility to request a new type of lead and/or modifications to qualified lead forms 455a. Similarly, the publisher's administration facility interface 450b for publisher users 433b, generally, provides the user with: a sign up and/or login page 451b; the ability to select categories, subcategories, lead type, media type (e.g., search, context, display, multimedia, etc.) 456; the ability to manage how ads are displayed, accounts and/or activities 457; general report management regarding their accounts and/or activities 454b; and a facility to request a new type of lead and/or modifications to qualified lead forms 455b. The partner's administration facility interface 450c for partner users 433c, similarly, provides the user with: a sign up and/or login page 451c; the ability to establish and set up advertisers to use the LBS 458; the ability to manage accounts and/or activities 459; and general report management regarding their accounts and/or activities 454c. In an other embodiment, all of the subcomponents of the various user interfaces 450a-c may be recombined and/or deployed in different combinations and/or as one interface applicable to all users.

Consumer Interaction

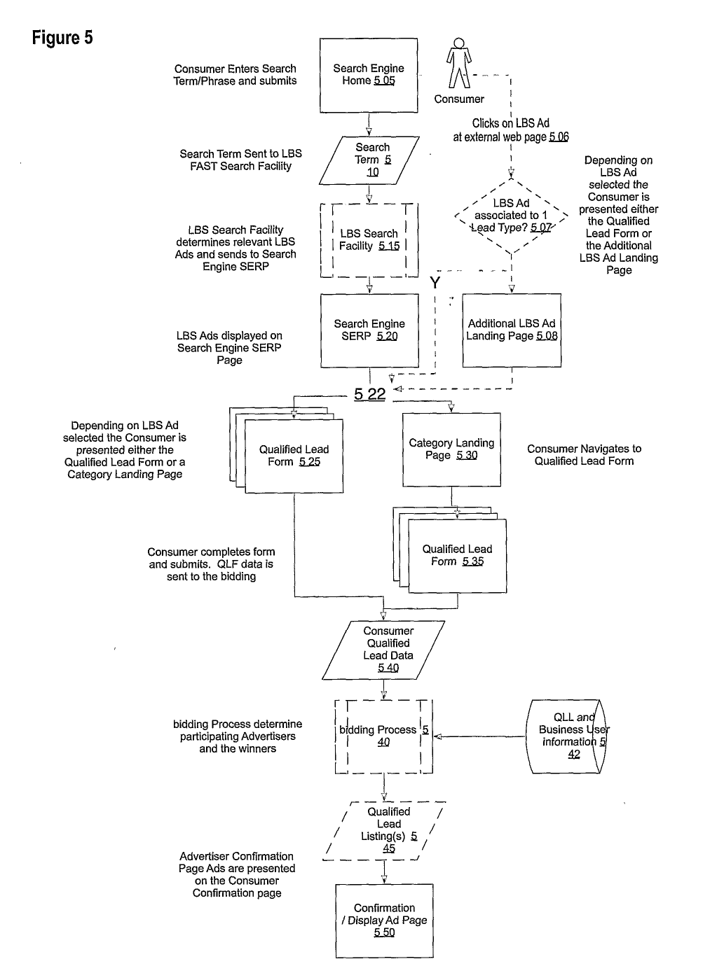

FIG. 5 is of a logic-flow diagram illustrating a consumer interface for the LBS. With regard to the administration facility and consumer interaction, the interfaces have options that allow the users to interact with and/or configure the LBS.

In this embodiment, a consumer enters a search term at a search engine 110 and submits the search 505. The search term 510 is sent to the search facility 515, which determines what ads are relevant to the supplied search term (e.g., by comparing tag types) and sends search engine results page (SERP) to the search engine. In an alternative embodiment, the consumer enters a search term at some external page (e.g., on a web blog about cars), and the LBS employs a web spider that crawls URLs for keyword terms 510. The results of the spider crawling for keyword terms 510 (including logs of searches conducted at the external, e.g., web blog, sites) are then supplied to the search facility 515. The ads are displayed on the search engine SERP 520. In an alternative embodiment, the ads are displayed in an external site (e.g., as ads and/or search results in a web blog with a search facility). Depending on the ads that are selected by the consumer 522, either a qualified lead form 525 or a category landing page 530 will be supplied. In the case of a category landing page 530, the user may navigate through various categories of goods, services, topics, etc., which at some point would lead to a qualified lead form for the selected category/topic 535. The consumer would then fill out the qualified lead (e.g., a web form) form via their client browser, and the web form data 540 for the lead form would be sent (e.g., via an http post) to the bid and billing component 130 where it will match bids and qualified leads 540. This matching will result in qualified lead listings 545 and results in the display of ads by the winning bidders to consumers on a confirmation page 550.

In an alternative embodiment, the consumer is at an external web page that already contains LBS ads 505 and clicks on the ads 506. Depending on the type of LBS ad selected by the consumer 507, the consumer is either presented with the qualified lead form 522 or with an additional LBS landing page 508 prior to displaying the qualified lead form 522.

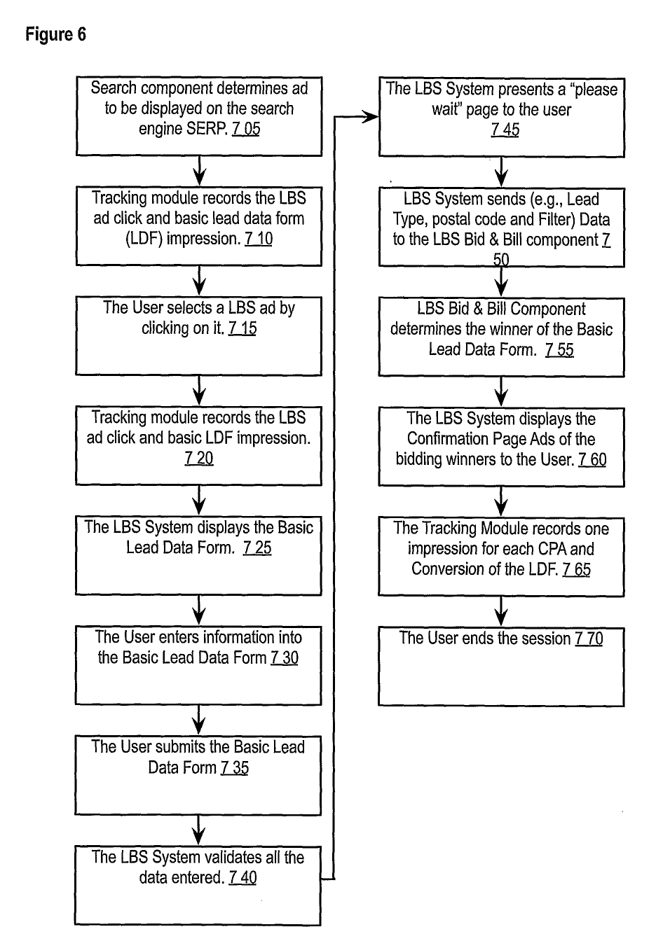

FIG. 6 is of a logic-flow diagram illustrating a consumer experience for the LBS. In yet another embodiment, a consumer may experience the following course of events:
1) The search component determines the relevant LBS ad to be displayed and displays (e.g., up to 4 LBS) ads on the search engine SERF 605.
2) The Tracking module records the LBS ad click and basic lead data form (LDF) impression 610.
3) The consumer selects a LBS ad by clicking on it 615.
4) The Tracking module records the LBS ad click and basic LDF impression 620.
5) The LBS System displays the Basic Lead Data Form 625.
6) The User enters information into the Basic Lead Data Form 630.
7) The User submits the Basic Lead Data Form 635.
8) The LBS System validates all the data entered 640.
9) The LBS System presents a “please wait” page to the user 645.
10) The LBS System sends the Lead Type, postal code and Filter Data to the LBS 650.
11) The LBS Bid & Bill component determines the winner of the Basic Lead Data Form (i.e., bid and lead matching logic is used to determine winner a bid winner) 655.
12) The LBS System displays the Confirmation Page Ads (CPA) of the bidding winners to the User 660.
13) The Tracking Module records one impression for each CPA and Conversion of the LDF 665.
14) The User ends the session 670.

In an alternative embodiment, after or instead of item 6) above, the consumer would enter data into the Detailed Lead Data Form. If the user enters bad information at item 6) (e.g., not completing required field(s) or entering invalid data, the LBS will present the user with an error message instructing them to correct the error.

In another embodiment of the interface, the consumer may view up to 4 LBS advertisements from the search engine (e.g., Accoona.com) search results page, publisher or partner web sites. Based on linguistic analysis of keywords from search queries or web page contexts, a relevant LBS ad(s) shall be displayed. The Consumer shall be able to select a LBS ad and be presented a lead data form or a full result set of LBS ads, which will then lead the consumer to a lead data form. The Consumer will fill out the lead data form(s) and submit. In one embodiment, there are two levels of the lead data form; a “Basic,” requiring a minimal amount of data to be entered and a “Detailed” form with additional data that may be entered. After submitting the form, the consumer will be presented a confirmation page containing from 1 to 4 business users' ads (i.e., the confirmation page ad). These winning bidders (e.g., advertisers) have the opportunity to follow-up on the awarded lead.

### Lead Data Form

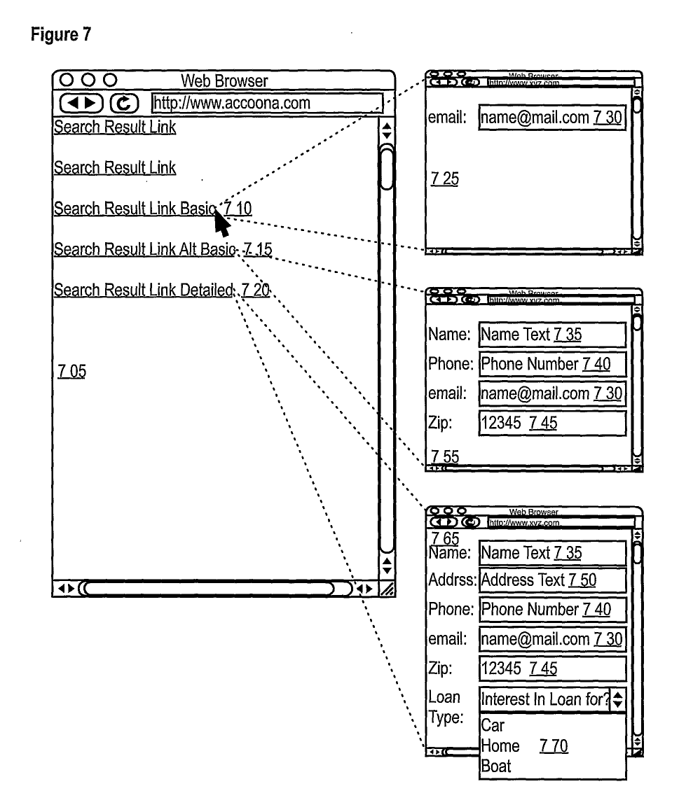

FIG. 7 is of a block diagram illustrating a lead data form. The lead data form may be presented in many different formats. In one embodiment, an HTML web page is used to present the user with a web form. In another, a dynamic html (e.g., AJAX based) panel may be provided to the user with web form elements, which thereby reduces web page loading and user context switching. In one embodiment, when a user clicks on search results 710 on a search results page 705, lead data forms may open to the consumer as a consequence 725.

In one embodiment, a ‘basic” lead data form 725, at its most basic, would include at least a single and preferably unique personal identifier. In general, at least an email address 730 should be supplied. Alternative unique identifiers may also be supplied, such as, but not limited to: drivers license number, personal digital object identifier, an IP address (e.g., prepopulating a text field), social security number, an account number (i.e., within the context of a given site, e.g., a credit card number), user name (e.g., within the context of a given site), and/or the like. In such a basic embodiment, the identifier could be used to provide further information about the user. For example, a lookup of the ISP supplying the user's IP address and/or email may reveal a locality and general region for the user. A data base search based on the users social security number, drivers license number, etc. may return not only geographical and more detailed personal information, but it may also provide the basis for a query to a credit rating service, which could return financial credit information for the user. In an alternative embodiment basic lead data form 755, the form would capture the consumers name 735, phone number 740, email address 730 and zip code 745. In addition, the LDS may present consumers with more detailed lead data forms 765. The context of these forms may vary based on the nature of goods, services and/or topics being viewed by the consumer. For example, a detailed form may require that a consumer also provides an address 750 and specifies the nature of their interest for a particular type of good and/or service 770 (e.g., what type of loan they are interested in). In such a case, the consumer may have previously searched for loans at a web site, or otherwise clicked through loan related links. In one embodiment, the consumer has stored profile information that may be read and used to prepopulate the fields of the lead data form. This profile may be stored on the consumers computer client (e.g., in a web browser cookie file) or as a profile at the LBS. In the case of the user profile being stored at the LBS, the user's client would have a uniquely identifying cookie file, which could be used to locate the consumer's profile at the LBS through a search based on that unique identifier. In one embodiment, the LBS prepopulates the forms for the user. In an alternative embodiment, the information is provided to the LBS without user interaction.

The information entered by the user into the lead data form may be sent to the LBS via an http post command. In one embodiment, the information formatted in XML in field, value pair notation, allowing for eased parsing. Thereafter, the LBS may store the parsed information in an LBS database. In one embodiment, certain types of forms may be associated with exclusive, semi-exclusive, and non-exclusive lead opportunities. For example, if a consumer indicates interest in particular home, or a home loan for a specific house, the lead may be made available on an exclusive basis, i.e., only one bidder may win. While other items may require that there is only a limited pool of winning bidders, e.g., say three or four. Yet other types of leads may have an unlimited number of bidders attempt to exploit the lead. The exclusivity of a lead is an attribute which may be specified when creating and/or applying a lead type to a certain kind of lead form. Ergo, consumers that fill out specific lead forms are creating leads of a certain type.

### Lead Data Verification Facility

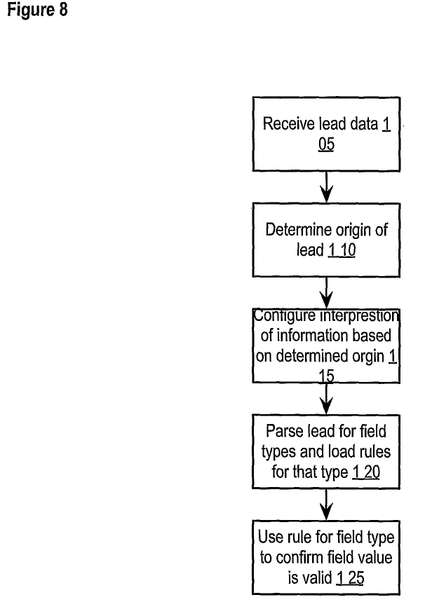

FIG. 8 is of a logic-flow diagram illustrating a lead verification facility. Initially, the lead verification facility 140 obtains data 805 from a consumer (e.g., receiving an XML field/value paired lead data form). In one embodiment, the verification facility uses the IP address from where the lead data was received to determine the country of origin 110, and therefore the language employed 115. In another embodiment, the lead data form includes a field specifying the language being used. The verification facility may then parse the lead data form field types (e.g., as being the first entry of a field/value pair) 120. For example, if the verification facility receives a basic lead data form with a single field/value pair of:

<email address>aName@anAddress.com</email address>

then the verification facility would determine that “email address” was the field type. The verification facility would then be able to search the LBS database for rules associated with a field type “email address.” The database might return a rule that requires the syntax of the address to be of userName@DomainName.TLD. For example the verification process may also include logic where the verification facility would perform a “whois” on the DomainName.TLD to make sure it is an existing domain. Similarly, each field type may have one or more associated verification rules that may be retrieved and performed by the verification facility. In one embodiment, the verification facility may provide a percentage as a rating of the validity of the lead (e.g., if the email country of origin and the address seem to be from two different continents, this may put the validity of the supplied information into question). In another embodiment, the verification facility may provide rankings for leads for a common category, type, area, etc. For example, if a user supplies financial information as part of a lead data form, that consumer's credit rating may be retrieved, and one consumer's lead may be ranked higher than another's based on varying credit ratings.

In one embodiment, after the consumer submits information via the lead data form, the lead data verification facility 120 will validate the data submission to eliminate bogus lead data, define and limit “bad” lead data and result in the best quality verified data. Verification occurs prior to sending the lead data to the winning bidders. It may occur prior to the consumer receiving a confirmation page. Alternatively, verification may occur prior to billing a winning bidder and sending them the lead data. In one embodiment, if either a telephone number or email address meets a rule verification threshold, a confirmation page can be sent to the consumer. In another embodiment, manual verification may occur when a bidder is asking for a refund.

### Search Facility

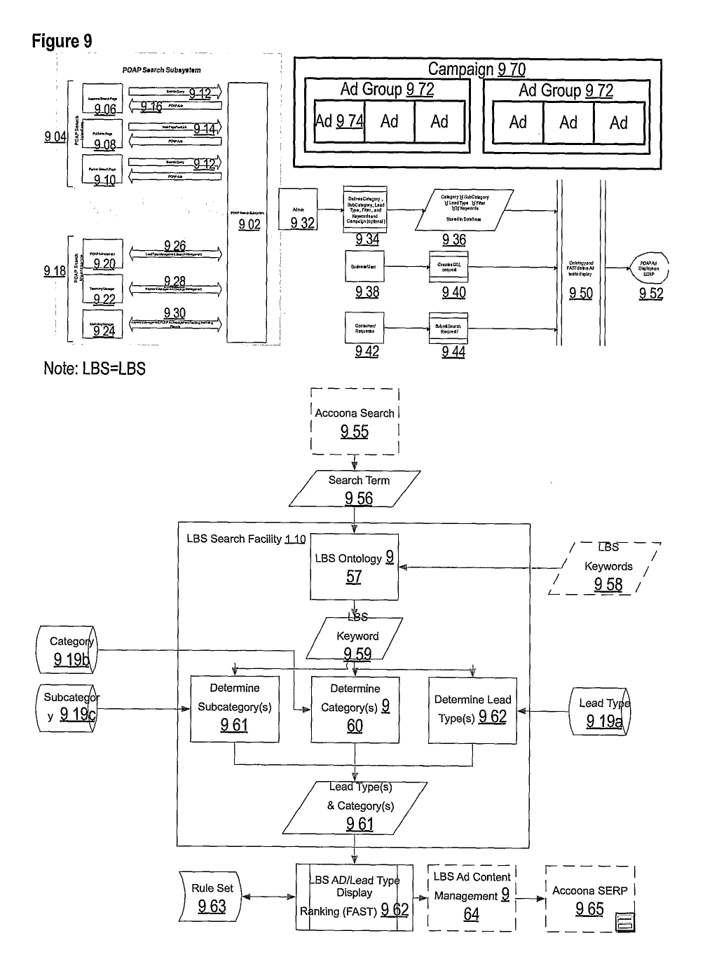

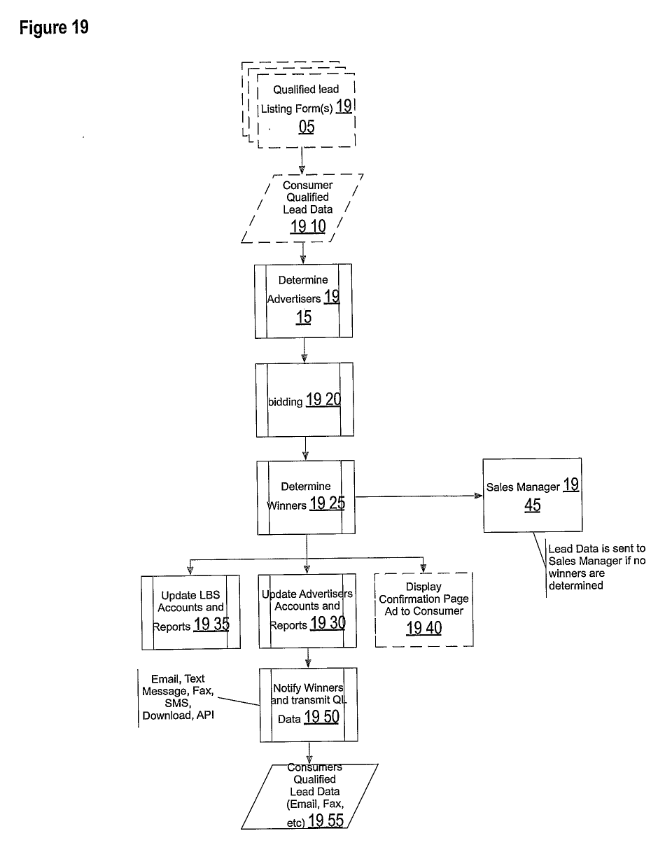

FIG. 9 is of a block and logic-flow diagram illustrating a search facility. In one embodiment, the search facility 110 operates as a World Wide Web search engine 955. However, alternative embodiments may include dedicated product search engines, web pages that redirect searches, and/or the like. A user will generate a search and that search term 956 is passed to the search facility 110. The term will be compared to the existing LBS search ontology 957 and the search facility may then compare against LBS keywords 958. In so doing, the search facility will identify the LBS keywords that best match the supplied term 956, and use the LBS keywords 959. With the LBS keywords 959, the search facility may then determine the categories 960, sub categories 961 and lead types 962 that are appropriate to the keywords. It may do this by searching the LBS database 919a-c for such matching criteria. The lead types and sub/categories are then provided 961 for use to query the LBS database for matching LBS ads 962 based on matching rule sets 963 (which will be discussed in greater detail such as in FIGS. 19-21). The LBS ad content management component 964 may then make use of those ads to supply them into confirmation pages, i.e., supplying them as ads as part of the search engine results page 965.

In another embodiment, the search facility 902 may be viewed as having two types of connections for interactions: a search interface 904 and an administration facility interface allowing for search facility maintenance 918. Consumers 906, publishers 908 and partners 910 may use the search interface (e.g., web pages), to provide search queries 912 and web page/text links 914, and receive LBS ads in response 916 from the search subsystem. In addition, LBS administrators may use the maintenance interface 920 to refine and manage search lead types 926. Also, a taxonomy manager 922 allows for the management of keywords and search ontologies 928. For example, the Taxonomy Manager may perform the following tasks: manage keywords and associated weights used in the search, both on an individual keyword basis and in bulk operations (load, update, scale, increment, reset); manage lead type ontologies; manage slang ontologies; and/or the like. The marketing manager interface 924 allows for keyword management, LBS ad management, ranking and the generation of marketing reports 930. As such, the Marketing Manager may perform the following tasks: alter placement weights for LBS ads, lead type, subcategory, and category; manage lbs ads (create, edit, activate, deactivate, delete); generate and view marketing reports on the search subsystem; and/or the like.

Ads

In one embodiment, a consumer enters their search query in a search engine or partner search page and the query is sent to the search facility. In such a case, the response to the query will be a set of LBS ads that best match the search context of the query. In the case where the search facility finds no suitable LBS ads to return, a default set of ads may be returned.

Ads may be created through the advertiser administration facility's 150 interface 932. The interface allows users to define various ad attributes, such as: categories, subcategories, lead types, filters, keywords, campaigns, and/or the like 934. The ad attributes may be structured as XML field/value pairs. In one embodiment, the advertiser administration facility 150 interface (e.g., a web form) would allow a user to enter field and values into a table, from which the values would be reformatted into the appropriate XML format and sent 936 for storage in the LBS database. Thereafter, the ads may be called by the search facility based on its ontology 950 and provided for display as part of a page of search results 952.

Ads may display if at least one active qualified lead listing is associated to the ad lead type. In one embodiment, following elements may be used to uniquely identify an LBS ad:
Category String: (e.g., 3 categories per string, no limit to number of strings)
Lead Type
Description
Keyword(s)
Campaign ID
Ad Group ID
Ad Type
Media Type: e.g., Text, Image, Video, Multimedia, URL file name and location, etc.
Creative
Creative Name: e.g., for use with display ads to identify specific offers.
Landing location: e.g., Base URL.

For example, the following table illustrates a sample ad/entry:

| Field | Value |
|---|---|
| Category | Financial, Insurance, Auto |
| strings | Auto, Financial, Insurance |
| | Travel, Recreation, Insurance |
| Lead Type | ATV Insurance |
| Description | A contract (policy) in which an all terrain vehicle (ATV) |
| | is insured against theft or damage. Many states require |
| | drivers to have ATV insurance when riding on state- |
| | owned land. Your home owners policy might not cover |
| | drivers if they ride off their own property. |
| | Comprehensive coverage covers the loss of an ATV and |
| | its custom parts and equipment due to theft, fire, |
| | vandalism, or other similar damage. |
| Keywords | ATV insurance, all terrain vehicle insurance, off-road |
| | vehicle insurance, ATV, auto insurance, quotes, atv, |
| | ATV theft, ATV crash, ATV accident, off-road vehicle |
| | accident, Honda, motorcycle insurance, Suzuki, |
| | car insurance, goldwing |
| Campaign ID | ATVCampaign123 |
| Ad Group ID | LEADTYPEGROUP123 |
| Ad Type | Test (‘Test’ or ‘Production’ - This will allow for certain |
| | ads to go back into production when campaign has |
| | ended.) |
| Media Type | Text |
| Creative | ATV Insurance |
| Creative name | ATV Insurance |
| Publisher | Non_specific (e.g., the LBS would automatically |
| | provide a landing area such as |
| | publisher_site.com/?utm_ . . . ) |

In one embodiment, the XML for this ad may look like:

```
<Ad_ID#123>
  <Category> Financial,Insurance,Auto;
Auto,Financial,Insurance;  Travel,Recreation,Insurance;
</Category>
  <Lead Type> ATV Insurance </Lead Type>
  <Description> A contract (policy) in which an all terrain
vehicle (ATV) is insured against theft or damage. Many states
require drivers to have ATV insurance when riding on state-
owned land. Your home owners policy might not cover drivers
if they ride off their own property. Comprehensive coverage
covers the loss of an ATV and its custom parts and equipment
due to theft, fire, vandalism, or other similar
damage.</Description>
  <Keywords>ATV insurance, all terrain vehicle insurance,
off-road vehicle insurance, ATV, auto insurance, quotes, atv,
ATV theft, ATV crash, ATV accident, off-road vehicle
accident, Honda, motorcycle insurance, Suzuki, car insurance,
goldwing</Keywords>
  <Campaign ID> ATVCampaign123</Campaign ID>
  <Ad Group ID> LEADTYPEGROUP123</Ad Group ID>
  <Ad Type> Test </Ad Type>
  <Media Type> Text </Media Type>
  <Creative> ATV Insurance </Creative>
  <Creative name> ATV Insurance </Creative name>
  <Landing>publisher_site.com/?utm_....</ Landing>
</Ad_ID#123>
```

Once ads are provided to the LBS, bidders 938 may create a qualified lead listing request 940 for use by the search ontology 950 for displaying ads 952. Also, at this point, consumers 942 may submit searches 944 and the search facility may use its ontology 950 to display ads that are resulted to the search request.

In one embodiment, ads are textual words and/or phrases. The words and/or phrase represent a service/product that the consumer may be interested in. Based on the search facility's ontology, ads may be displayed in a direct/indirect correlation to the search term entered by the consumer; i.e., search term “car insurance” yields ads for: Auto Insurance, Auto Loan. LBS ads may be associated to lead types or to a group of additional ads. All lead types may be associated to lead data forms.

Text ad formats may vary dependent upon publisher requirements and describe how ads will display. Ad formats, similarly, may be specified via field/value pairs. In one embodiment, the ad format is made part of the ad. In another embodiment, the ad format is saved separately in an LBS database and may be associated with an ad (i.e., via an Ad_ID#), campaign (i.e., via a Campaign_ID), etc. Ad format fields may include:

Ad listing: e.g., show ad with 1-5 other ads per page view.
Maximum length: e.g., N characters long.

Abbreviated listing: e.g., show ad with 1-3 ads per page view.
Maximum length: e.g., N characters long.

Listing with 1 to many ads.

Display ads format parameters.

Additionally, a Marketing Manager (as well as an LBS administrator or a bid and billing administrator) may have the ability to apply a ranking to the LBS advertisement. The ranking is a criterion in determining the placement of the ad on the a search page and/or partner/publisher pages. The ranking will be used to give special placement consideration to certain LBS ads. In one embodiment, the ranking may be an attribute that is embedded within the ad itself.

Ad Campaigns

Campaigns may be used to organize and execute advertising campaigns.

The attributes of a campaign may be as follows:

Unique ID

Name

Description

Lead Type
Ad Group ID
Ad Group Name
Ad type (test or production)
Creative ID
Creative Name
Creative Type
Campaign Schedule (all parameters may not be required)
   Start Date
   Stop Date
   Scheduled number of impressions
   Scheduled number of clicks
Created by
Timestamp

Campaigns attributes may govern ad groups within the campaign, and ads within the ad group(s). A campaign may have multiple ad groups. An ad group may have multiple ads. In one embodiment, ad campaigns may be managed by LBS administration. The campaigns act to schedule specified times for ad and ad groups to be employed.

If an ad is part of a campaign, it will follow the parameters of the campaign until the end of the campaign. Upon campaign completion, the ad may or may not return to the group of live POAP ads. However, an ad shall be allowed to go live, even if it is not part of a campaign.

Relevancy

In one embodiment, the N^{th} position of ad text listing on a search results page may display the text of “more . . . ” and may link to either more of, or the entire, ad result set based on the query. In such a case, the result set may be displayed on an search engine marketing landing page. In another embodiment, an additional partial set (e.g., 5 additional ads) may be displayed on the SERP.

In one embodiment, ad relevancy may be based upon query context relevancy of indexed fields in the ad server. In such an embodiment, elements that uniquely identify ads are indexed in the ad server.

Ad relevancy ranking may be based upon 1 field's importance over another. In one embodiment, ad text relevancy may be ranked as being the most important. Any and all of the ad identifying attributes may also be ranked. When a results set returns ads from the same “Lead Type” or “Ad Group,” the most relevant ad shall display based upon query context. When two or more ads have identical query context score, ranking of these ads may be determined by additional scoring. For example, additional scoring may be determined by keyword query popularity. Keyword query popularity may be a numerical value based on information obtained from query log analysis and/or Wordtracker data. The keyword popularity may be refreshed at regular specified intervals through cron jobs, and/or the like.

Ad Tracking

Certain events will be tracked for later reporting. Analytically, it is helpful to look at tracking events from two perspectives: (1) from the perspective of a search engine acting as an advertiser, and (2) from the perspective of a bidder as advertiser and the LBS as publisher. As such, the following table details nomenclature for each perspective:

| | Nomenclature | |
|---|---|---|
| | Search engine | Bidder as |
| Event Description | as advertiser | advertiser |
| LBS Ad is displayed to the | LBS Ad Impression | n/a |
| consumer (possibly along | | |
| with other LBS Ads) | | |
| Consumer clicks upon LBS | LBS Ad Click | n/a |
| Ad, LDF is displayed | | |
| Consumer submits Basic | Simple LDF Conversion | Confirmation Ad |
| LDF and is shown | | Impression |
| confirmation page along | | |
| with one or more business | | |
| user ads | | |
| Consumer submits Detailed | Detailed LDF | Confirmation Ad |
| LDF and is shown | Conversion | Impression |
| confirmation page along | | |
| with one or more business | | |
| user ads | | |
| Consumer clicks upon | n/a | Confirmation |
| Confirmation page ad | | Ad Click |

In one embodiment, a tracking module is part of the search facility and it records LBS ad impressions. The tracking module may also record LBS ad clicks, i.e., each LBS Ad click may be associated with its corresponding impression so as to preserve user path information. In addition, the tracking module may record Basic and Detailed LDF conversions, i.e., each LDF conversion shall be associated with its corresponding click (and, by extension, its corresponding impression) so as to preserve user path information. Also, the tracking module may record Confirmation Ad Impressions, i.e., each CPA impression shall be associated with its corresponding LDF conversion (and, by extension, its corresponding LBS Ad impression and click) so as to preserve user path information. The tracking module also may record Confirmation Ad Clicks, i.e., each CPA click shall be associated with its corresponding CPA impression (and, by extension, its corresponding LBS Ad impression and click, and its corresponding LDF impression and click) so as to preserve user path information. Tracking information may be retained long enough to generate reports for LBS administrators and bidders.

### Bidding Advertiser Administration Facility

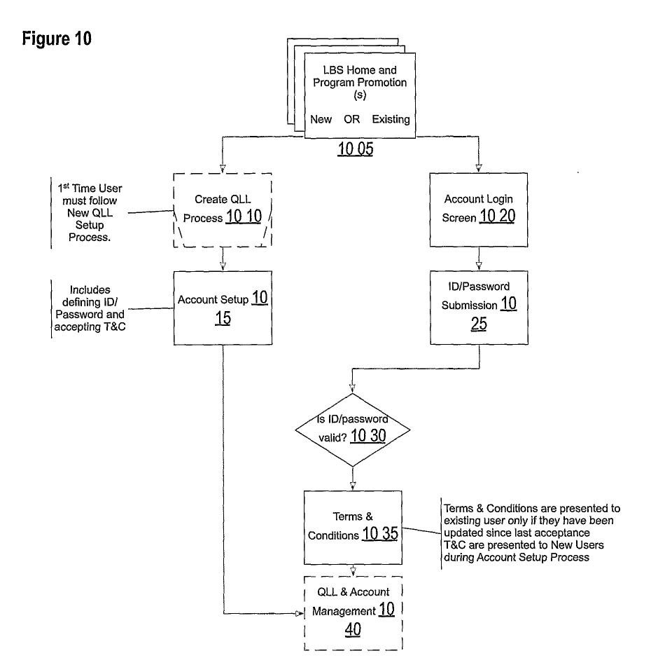

FIG. 10 is of a logic-flow diagram illustrating an advertiser administration facility. All new, first time bidders (i.e., a user) may create a Log In ID and Password following the Qualified Lead Listing (QLL) creation process. Bidders may arrive at the LBS home 1005 and may proceed to log in to their accounts 1020, if they already have an account, or create a QLL if they are new users 1010. Upon getting to the login screen 1020, the user may supply their user ID and password 1025, and the advertiser administration facility will validate if the password matches one in the LBS database 1030. In one embodiment, a terms and conditions of use screen may be shown to the user 1035 and require the users assent before allowing the user to go further; this is of use when terms have changed and there is a desire to have existing users assent to new terms of use. Upon such assent 1035, or upon a new user creating a QLL 1010 and setting up an account 1015 (e.g., creating a username, password, supplying billing information, accepting terms and conditions, etc.), the user may use the advertiser administration facility 150 to manage QLLs and their account 1040.

In one embodiment, the LBS New Account Creation Process (i.e., Signup) is available from the LBS Advertiser Facility's Home Page and LBS promotional landing pages. For the new QLL setup process for new or existing advertisers, all information is retained when the ‘Next’ or ‘Previous’ buttons are clicked.

Interface and Logic

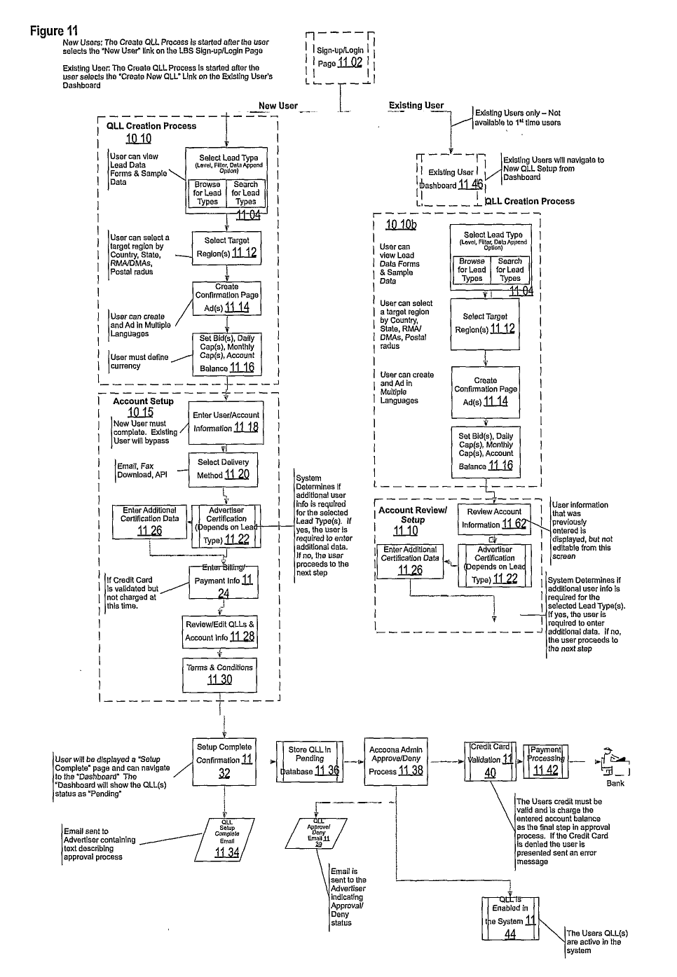

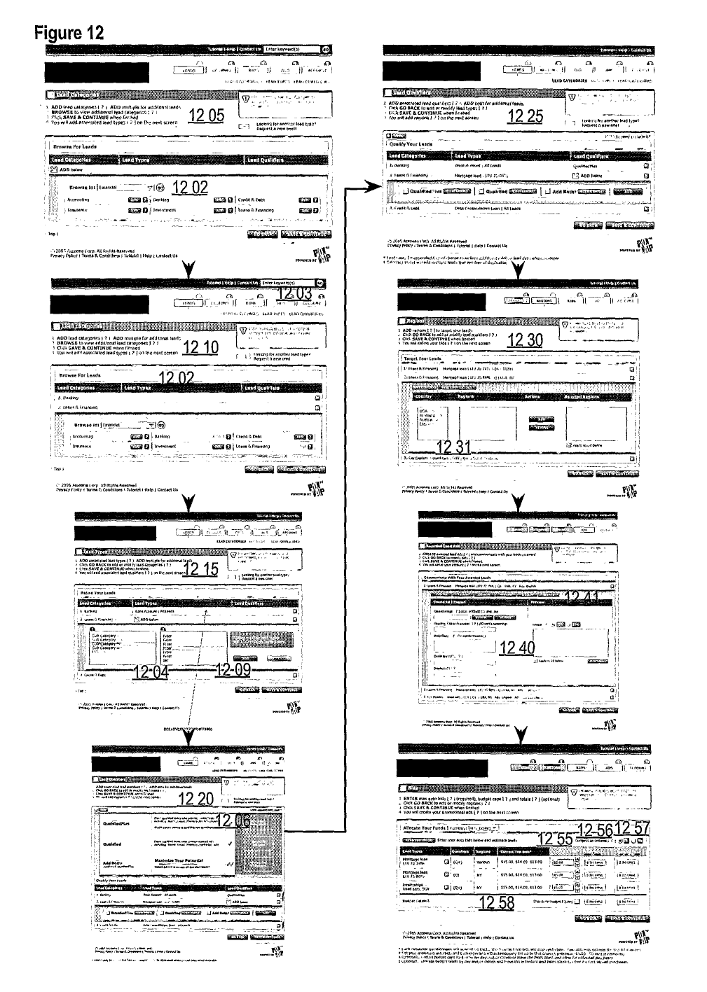

FIG. 11 is of a logic-flow diagram illustrating qualified lead listing creation. FIG. 12 is of a block diagram illustrating the user interface for qualified lead listing creation. In the discussion of the flow of FIG. 11, the user interface elements of FIG. 12 will be discussed so as to provide an example implementation of interface operation. Upon signing up 1102, a new user will engage in the creation of a qualified lead listing 1010. The user may select lead types in two ways 1104: by browsing 1202 or searching 1203 for lead types (in either case the user may view sample lead forms with sample data). The user may specify lead types by specifying levels, filters 1204, data append options 1206, and/or the like.

In one embodiment, the user has the option of appending data to lead data that they are awarded. Data append is a process where additional information on a qualified lead listing is added to the lead data received in the lead data form; the option is made on a lead type/filter/data, level/target, individual and/or region level. This data append may contain lifestyle marketing data at the household level which is received from database marketing providers. This data may be refreshed on a weekly to monthly basis (e.g., via cron job). In one embodiment, the data append shall cost the user a per-transaction fee for inclusion with the lead data. Data append may be applied after the process which defines the winner of the lead data bidding. The reason for this is that the append, in such a scenario, will not be applied should the cost associated with the append exceed the bidder's defined cap.

In one embodiment, the user has the option of defining the number questions and/or level detail of questions and answers they wish to receive that are associated with any given lead. As has been discussed in FIG. 7, in one embodiment, initially, there may be two levels of detail for leads: basic and detailed. This level of detail may be set as an attribute for a QLL, qualified lead form (QLF), and a lead itself.

Upon selecting a lead type 1104, the user may specify the target regions for the QLL 1112, 1230. The user may provide a geographic region as selected by country, state/province, demographic market areas (DMA), regional market areas (RMA), postal code, and/or a radius (e.g., 1, 5, 10, 20, 50, 100 miles, etc.) about such a region. In one embodiment of lead type selection 1104, the user may select the category that is most closely describes the desired leads. The selected category becomes highlighted and all associated sub-categories display in the sub-category list box 1204. Similarly, the user may select the sub-category that most closely describes the desired leads. As such, the selected sub-category will become highlighted and all associated lead types display in the lead type list box (i.e., lead type data level is also displayed with the lead type) 1206. Similarly, filtering 1204 and dynamic descriptive lead type text box 1206 may populate with a more detailed description of the leads on which the user will bid. For example, making a selection:
Financial>Loans>Home Equity Loan>Good Credit Rating would yield descriptive text:
This selection will return leads that are interested in Home Equity Loans and have described themselves as having a Good Credit Rating

At which point the user may click the “Add” button 1209 and the selected lead type/filter is added to the selected lead type list box. In an alternative embodiment, a user would enter search terms 1203 for lead types, and matching lead types would be listed for the user's review and/or selection.

Then the user may create a confirmation page, i.e., ads 1114, 1240. In one embodiment, during the confirmation page creation, the ad is dynamically created and displayed to the consumer user (i.e., as the ad text, image, etc is being entered, the ad will be dynamically created on the page for the user). As the user enters the required data for the confirmation page ad, they may provide the following: uploads of an image for the confirmation page ad; enters text to be display with the confirmation page ad; enters the url for their company; enters the display url; and/or the like. The user may verify that the confirmation page ad contains desired selections. It should be noted that although a user may create/define one confirmation page ad for each QLL, that same confirmation page ad may be associated to more than one QLL.

Users may specify a region by using a country, state, RMA/DMA, postal code, and/or the like 1231. Then the user may specify desired regions 1112, for each such region they may create one or more ads; this allows users to create ads in multiple languages for multiple regions 1241.

Then the user may set the bid value 1255, daily cap 1256, monthly cap 1257, account balance 1258, etc. 1116. At this point, the user's (i.e., prospective bidder's) specified settings may be saved as a qualified lead listing, which will be used to make bids for leads. In one embodiment, the system may display the top three leading bids. When entering bids, the user enters a maximum bid amount for each QLL (Lead Type/Data Level/Filter), which is greater than the minimum bid amount for the QLL bidding. In addition, the user may enter a daily and monthly cap amount for each QLL (Lead Type/Data Level/Filter). For the convenience of the user, they may select a cap depletion level at which they would like to receive a notification e-mail. The user may specify the currency amounts they want for each QLL bid type (by default, the user's default account currency type is used).

As this is a new user 1102, they must set up their account 1015. Initially, the user will enter their user and account information (e.g., user name, company, address, and/or the like) 1118. User account information may include following types of field identifiers:
*First Name
*Last Name
*Address Line 1:
Address Line 2:
*City:
*State/Province:
*Postal Code:
*Country
*Phone Number
Cell Phone Number:
Fax Number:
*E-mail Address
*Confirm E-mail address:
*Data Transfer Method information (at least 1) (e.g., Fax number, SMS number, E-mail, API, Self-Retrieval)
Company Name
Company Owner or President's name:
Company Tax ID
User job title
Company direct phone (can be same as users)
Company website
DUNS Number

In setting up the account, the user may specify the delivery method for leads (e.g., email, facsimile, downloads (e.g., FTP, HTTP, etc.) in various formats (e.g., Excel), RSS, SMS, instant messenger notices, via API, etc.) 1120. An Advertiser PULL API may be used to transmit either Basic or Detailed information as well as any applicable Data Append information. Advertisers have the option to view QLF data online at the advertiser web site (“web view”); to download it in excel format from the advertiser web site (“excel view”); and to subscribe to it via RSS feed from the advertiser web site (“RSS view”). These options are collectively “user pull” options. These pull options require log in prior to access. In one embodiment, if no method is selected, the user must manually self retrieve the lead by logging into their account. In another embodiment, if a lead is not retrieved within a specified amount of time (e.g., 2 business days), then the lead is awarded to another bidder (e.g., the next highest bidder); such an embodiment prevents leads from spoiling and/or expiring. In one embodiment, users may be able to retrieve data on a batch basis when they log into the account management facility. In one embodiment, if the user selects to retrieve the lead information from the LBS, and fails to retrieve data at least once in a 24 hour period, an e-mail reminder notification shall be sent to the user; should a the user fail to retrieve lead data on a consistent basis or for an extended period of time, their account and all associated QLLS may be suspended until action is take by the user to retrieve lead data.

Depending on the lead types that the advertiser wants, additional certification information may be required 1122. If so, then the user is prompted and must provide the additional certification data 1126. Thereafter, the user will need to supply billing and payment information (e.g., credit card, bank account, etc.) 1124. The user may then review and edit any QLLs and account information 1128 and will be presented with various terms and conditions 1130 to which they must assent to proceed with using the LBS.

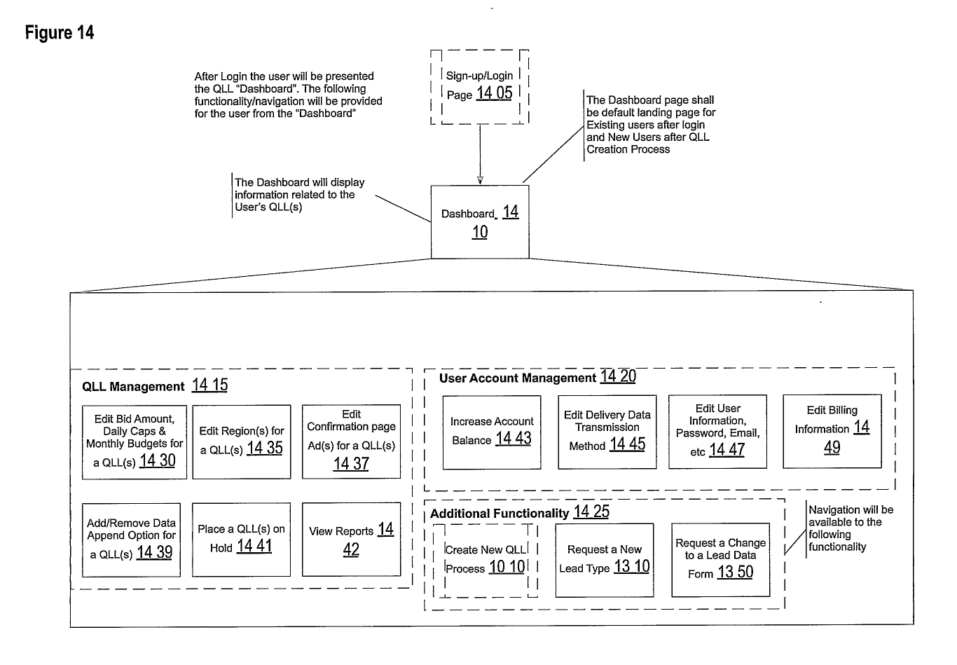

Qualified lead listing creation takes place similarly if the user has an existing account 1146. After logging on 1102, the user is shown their account status in a dashboard (see FIG. 14), which may show pending QLLs, account balances, and provide the user with options to manage their account 1146. At which point, the user may chose to create a QLL, in which case the process 1110b is the same as has already been discussed 1110. Upon creating a new QLL 1110b, the user may then review their account setup 1110, 1162. Here the user may see their previously provided 1015 account information 1162. As the new QLL may require a change in certification by the user, a determination is made based on the lead type selected by the user 1122. Depending on the lead types that the advertiser wants, additional certification information may be required 1122. If so, then the user is prompted and must provide the additional certification data 1126.

After setting up the account 1015 or account review 1110, the user will be presented with confirmation that setup is complete 1132. In one embodiment, the user is shown a dashboard page that shows current pending QLLs, account balances, account information, and provides options to manage the account 1132. A confirmation email may be sent to the user confirming the setup of the new QLL 1134. The new QLL may be stored in the LBS' database in a pending QLL table 1136. Administrative users may approve and/or deny the account and/or QLL creation 1138 and an email confirmation may be sent to the user 1139. If approved 1138, the users credit card is validated 1140. The QLL is enabled in the LBS and is now available to the bid and billing facility 130 for purposes of creating bids on leads 1144. If the user credit card is denied, the QLL and/or account validation is halted, and the user is sent an error message. Upon credit validation 1140, payment processing 1142 may take place via bank, etc.

Alternative Logic

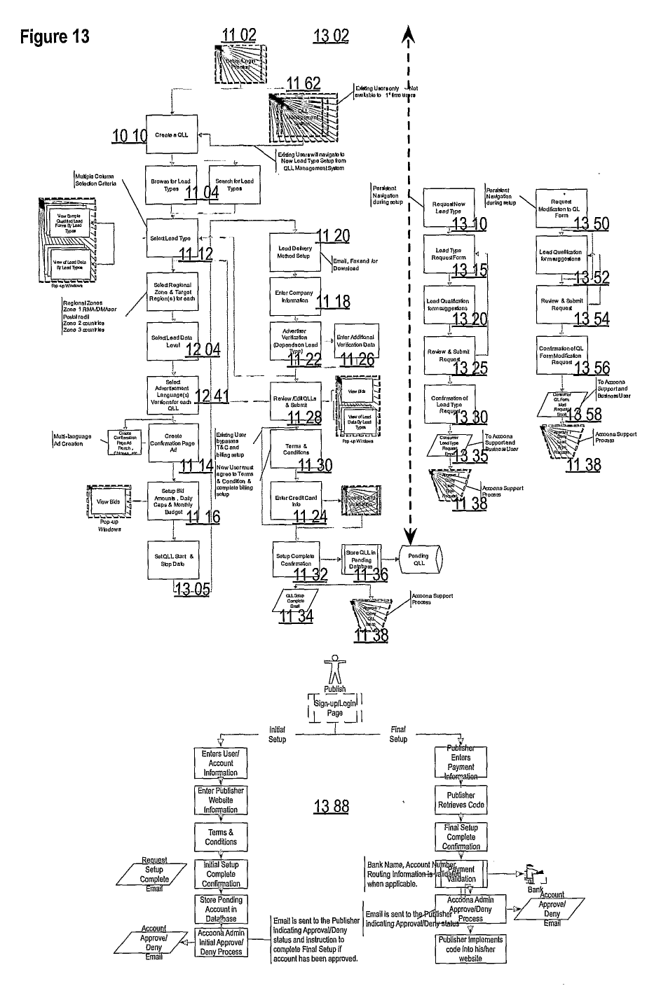

FIG. 13 is of a logic-flow diagram illustrating qualified lead listing creation and modification requests. The flow diagram generally to the left of the dashed dividing line provides another embodiment of what was already discussed in FIGS. 11 and 12. It is provide to show that the components may be re-arranged to achieve much the same effect and that other elements may be added without departing from the spirit of the advertiser administration facility 150. For example, in this embodiment the advertiser administration facility obtains a start and stop date for the created QLL 1305, which will limit the availability of the QLL to such times. The diagram at 1388 shows yet another rearrangement for a publisher administration facility.

In addition, the advertiser administration facility 150 allows users to request new lead types 1310 and request modification to qualified lead forms 1350. Once a user select an option to request a new lead type from the management options in their account (e.g., a button on their dashboard), they may select from various lead types in a request form 1315. They may provide suggestions for various lead qualifications in a form 1320. The user may review and choose to submit the suggestion (or go back to make edits or further suggestions 1315) 1325. The user is provided with a confirmation of the lead type request 1330, and the request is sent to LBS administration for consideration 1335. Administrative users may approve and/or deny the account and/or QLL creation 1138. In an alternative embodiment, users may combine lead types to form new types, and the LBS may provide them automatically without administrative intervention.

Should the user request a modification to a qualified lead form 1350, they will be presented with a form where they may make suggestions for a new lead qualification form 1352. The user may review and choose to submit the suggestion (or go back to make edits or further suggestions 1352) 1354. The user is provided with a confirmation of the qualified lead form modification request 1356, and the request is sent to LBS administration for consideration 1358. Administrative users may approve and/or deny the account and/or QLL creation 1138. In an alternative embodiment, users may combine lead types to form new types, and the LBS may provide them automatically without administrative intervention.

Interface Options

FIG. 14 is of a block diagram illustrating an interface for an advertiser administration facility. The advertiser administration facility may provide an existing user 1146 with a dashboard view 1410 of their account after they log into their account 1405. In one embodiment, the dashboard displays information related to a user's QLLs (e.g., pending QLLs) and it acts as the default landing page for users after logging in. The dashboard may be presented as a series of management panels, e.g., one for QLL management 1415, one for user account management 1420 and one for additional functionality 1425. It should be noted that these panels may be mixed and matched, and that FIG. 14 shows only one exemplary view. The QLL management panel 1415 provides options for the user to manage QLL related matters. In one embodiment, the options are a series of web form buttons. In an alternative embodiment, the panels are popup lists containing selectable items. An edit amount item 1430 allows the user to view and edit current bid amounts, daily caps, monthly budgets, etc. for QLLs. This may be achieved by querying the LBS database for the user's outstanding QLLs and providing an updated webpage of the information to the user by way of a web form. Similarly, the edit region option 1435 allows users to change the region for witch a QLL will apply. An option exists to allow users to edit the confirmation page (i.e., ads) related to a QLL 1437. Further, options exist to add/remove/append data for QLLs 1439, place QLLs on hold (i.e., suspend them from being acted upon by the bid and billing facility) 1441, viewing reports 1442, and/or the like.

Example reports may provide a summary of leads received, and may be sorted and/or organized by any field (e.g., by category and subcategory fields). This may be achieved by performing a select query on the basis of desired fields on the LBS database and formatting the returned results into a desired report format. In one embodiment, reports can be downloaded via csv, Excel, html, text, and/or the like formats. Example reports and their constituent fields follow:

Category & Lead Type Summary Report
This report provides a summary of Leads received and is organized by Category and Subcategory.
User Input(s):
   Date Range only
Results set heading includes:
   Category
   Subcategory
   Lead Type
   Data Level
   Filter
   Region
   Number of Leads Received
   Average Cost of Leads Received
   Total Cost of Leads Received
Totals/Average Grouping:
   Group by Subcategory
   Group by Account
Totals/Average Values:
   Number of Leads Received
   Average Cost of Leads Received
   Total Cost of Leads Received

Regional Summary Report
This report provides a summary of Leads received and is organized by Target Region.
Users Input(s):
   Date Range
   Listing Selection (User may select 1, many, or all Listings)
Results set heading includes:
   Date Range Specified
   Listing(s) specified
Results set includes:
   Target Region
   Number of Leads Received
   Average Cost of Leads Received
   Total Cost of Leads Received
Totals/Average Grouping
   Group by Listing
   Group by Account
Totals/Average Values
   Number of Leads Received
   Average Cost of Leads Received
   Total Cost of Leads Received

Lead Data Summary Report
This report provides a summary of Leads received and associated Basic/Standard data, and organized by Listing
Users Input(s):
   Date Range
   Listings Selection
      User may select 1, many, or all Listings
Results set heading includes:
   Date Range Specified
   Listing(s) specified
Results set includes:
   Date Awarded
   Lead Award Reference Value
   Lead Cost
   All Basic/Standard information associated with the Lead.
Totals/Average Grouping
   Group by Listing
   Group by Account
Totals/Average Values
   Lead Cost

Lead Data Detail Report
This report provides detailed information for Leads received and associated Basic/Standard (and Detailed data if applicable), and organized by Listing
Users Input(s):
   Date Range
   Listing Selection (user may select 1 Listing ONLY)
Results set heading includes:
   Date Range Specified
   Listing specified
Result set includes:
   Date Awarded
   Lead Award Reference Value
   Lead Cost
   All Standard information associated with the Lead.
   All Premium/Detailed information associated with the Lead
   Any Data Append information associated with the Lead
Totals/Average Grouping
   Group by Listing
Totals/Average Values
   Lead Cost

Account Billing Summary
This report provides account history in a statement/invoice format, organized chronologically.
Users Input(s):
   Date Range (can only select month and year)
Result set heading includes:
   Account Number
   Account Holder's Name
   Account Address
   Month and Year Specified
Result set includes:
   Date of Transaction
   Transaction Description
   Include Transaction numbers or Lead Award numbers
   Payments and Credits
   Debit(s)
   Remaining Balance after each Transaction
Totals/Average Grouping
   Display ending account Balance

The user account management panel 1420, similarly, provides user engageable options, which allow the user to: increase the accounts balance available for QLL creation and lead bidding 1443, modify the method of delivery of leads 1445, edit user information (e.g., password, email, contact information, etc.) 1447, edit billing information 1449, and/or the like. Additional panels providing additional functionality 1425 may be provided. For example, options exist to allow the user to create a new QLL process 1010, request a new lead type 1310 and request a change to a lead data form 1350.

Publisher Program

Thus far, the advertiser administration facility 150 has been described with a view to a generalized bidder and/or advertiser. However, the advertiser administration facility 150 and the LBS may also operate allowing users to act as publishers. When the user wishes to act as a publisher (i.e., when the user wants to support search-query actuated LBS ads; e.g., the user may wish to support such ads on one of their blogs), then the user may engage the system and it will guide the user through a self-service process through the publisher sign in and setup process. The partner program supports distribution of the advertiser system to maximize advertiser acquisitions via 3rd party sales teams or partners with existing advertiser bases. The program provides quality traffic statistics as well as the opportunity for white labeling of landings.

In one embodiment, advertiser sales partner(s) are only authorized by an LBS administrator; this is to promote security and consistency. However, in alternative embodiments, all submissions to the partner program may be authorized by default. When establishing a partner account, there should be only 1 primary contact associated to the advertiser sales partner account; as such, only 1 login is used for the advertiser sales partner. Each advertiser sales partner shall have 1 to many advertisers/bidders within his/her account. Each business user/bidder account that is set up or managed by an advertiser sales partner (ASP) shall be defined as a member of an advertiser sales partner account. In this manner, the ASP shall be able to add a variable service charge to each individual business user account. In one embodiment, the service charge shall be a set as a percentage of lead price. The ASP shall be responsible for defining a cap that incorporates the percentage service charge. Thus, in such a scenario, the LBS need not incorporate service charge consideration into cap logic used during bidding eligibility.

Advertiser sales partner will have a administration interface similar to the advertiser/bidder, but tailored to the ASP. In one embodiment, the ASP top-level view displays and is organized by business user account names; e.g., accounts are listed alphabetically and displayed as hyperlinks that navigate to the business user account management system top level. In addition, new advertiser/business user set up shall be available from the ASP Interface. This allows the ASP to define the business user account name and service charge percentage. In general, the ASP may follow the business user set-up process as has already been discussed with regard to advertisers/bidders. The business user setup shall be identified as a member of the ASP's account and shall be available from the ASP interface. Thus, the ASP shall be able to: edit the service charge percentage associated with his/her business user(s); edit the account name associated with his/her business user(s); be able to perform any other account profile editing on the business user's account; and shall be able to suspend (and remove from Interface) any Business User within their account. In short, the ASP shall be able to edit the most attributes of the ASP account, which may include:
*Login ID/E-mail address
*Password
*Contact Name
*Company Name
Company Owner or President's name
Company tax id
*Address
*City
*State
Postal Code
*Country
*Telephone Number
Cell Phone Number
Fax Number
Company website URL

Similar to the advertiser/bidder scenario, advertiser service partner reporting shall be available from the ASP Interface. The ASP shall have the ability to review Business User data across accounts. Conveniently, Individual Business User reports shall still be available from the Business User drill down pages. In one embodiment, the advertiser service partner shall be provided with an LBS sales contact and support phone and e-mail address. In such an embodiment, the business user(s) who are setup or managed by and advertiser sales partner shall not be able to log into the business user account management system. Numerous other embodiments and service levels may be achieved.

For example, the LBS supports full-service, self-service and publisher partners. Although numerous variations and levels of management and authorization are possible, what follows is one set of partner programs:

A full-service advertiser white label partner may follow the same requirements of the advertiser sales partner, delivered within specific branded pages of the white-label partner. The full-service advertiser can only be established by an LBS Administrator. Business users that are within the full-service advertiser white label partner account shall be recorded as such. The self-service advertiser white label partner may follow the same requirements of the advertiser/business user, delivered within specific branded pages of the white-label partner. The self-service advertiser can only be established by an lbs administrator. The White Label Publisher may follow the most of the same requirements defined for Publisher. The white label publisher shall be capable of blocking specific keywords from delivering LBS ads. In addition, the White Label Publisher would receive 50% of the revenue share on gross revenue per lead (i.e., total sale to all business users who purchase the lead). Also, an additional 10% revenue share shall be available to White Label Publishers when the business user who purchased the lead was sourced by the same Publisher White Label partner. The white label publisher account shall only be setup by an lbs administrator.

When establishing a new account, or through an additional functionality option in the dashboard of their current account, a user may indicate their desire to act as a publisher. In another embodiment, publisher “Signup” (first-time user) functionality may be available from the LBS and/or LBS promotional landing pages. Upon selection of the “Signup” option, the user shall be presented the first page a registration/application page process. Once the user invokes the publisher option, the advertiser administration facility will go through establishing a publisher account for the user in much the same way as has already been discussed for the scenario of an advertiser/bidder. Namely, the user will provide: personal user Information; his/her banking information. After receiving this information, the LBS will verify and submit new publisher account request and the LBS will validate the information provided. Once validated, a confirmation page indicating that the LBS administration will review the request and follow-up via e-mail is provided to the user. LBS administration may review the publisher account request. Upon completion of the approval process, the applicable publisher APIs will be made available to the new publisher. As part of the setup, the user may specify that he/she wants to support contextual ad serving; if so, the user will be prompted to enter his/her personal information, which shall include the URL of the page that shall be contextually searched.

When going through the publisher setup process for first-time, users shall go through the process of completing a registration/application, receiving an approval email, supplying user information and selecting code to be plugged into the publisher's web application. The user shall have the ability to enter/submit (and later edit) the following information (e.g., in one embodiment, “*” indicating required fields):
First Name*
Last Name*
Address*
City*
State/province*
Zip/postal code*
Country (e.g., US at top of dropdown)
Phone number*
Company name*
Company owner or president's name*
Company tax ID
User job title*
Company direct phone (e.g., can be same as users)*
Company website URL*
Website URL for LBS if different from Company
Email address*
Confirm Email address*
Type of Business* (e.g., having a list of industry types to select)

Upon submission of the registration/application form, the form data shall be transmitted to the to an LBS Marketing Manager who will approve or deny the request. Upon submission of the request form, a confirmation page shall be displayed to the user indicating the process for approving the modifications, and if approved or denied, they will receive a follow-up email. In one embodiment, a Terms & Conditions agreement submission required prior to account setup. In one embodiment, if the Terms & Conditions that the user agreed to during their initial account setup has changed, the user shall be presented the new Terms and Conditions and required to accept or decline. Once the bank account information has been accepted, the user will be allowed to continue in the setup process and retrieve code for publishing POAP ads.

The user shall have the ability to pick up code for ad serving. In one embodiment, the code will allow two primary types of LBS ads to be served to a 3rd party publisher: search-query-actuated ads and contextually-actuated ads. The search search-query-actuated ads may employ the LBS search facility 110 API to receive keywords. The contextually-actuated ads may employ the LBS search facility 110 to receive URLs. The code will be uniquely generated to identify and track the following upon click through of LBS ad: a publisher ID; a unique Consumer ID; an LBS Ad ID.

In one embodiment, a second approval process requires the LBS Marketing Manager to monitor the account setup and set up ad serving test.

As with the advertiser/bidder account management portion of the advertiser administration facility, through the publisher program, account management system shall allow the user to view performance of their advertising (LBS ads). In addition the users shall have access to functionality to allow ability to add, edit, deactivate and/or remove LBS ads; and edit their user and billing information. In other words, the user shall be able to view the performance of his/her publisher account, change the performance summary timeframe, and have the ability to edit or update personal and banking information.

### Administration Facility

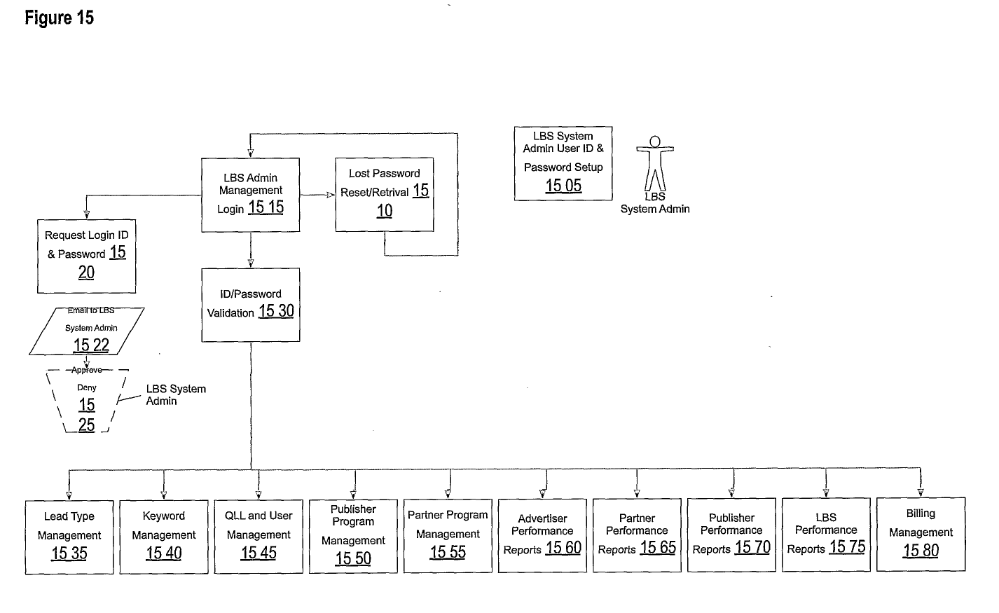

FIG. 15 is of a data-flow block diagram illustrating a basic overview of a administration facility. In one embodiment, the administration facility 140 allows authorized LBS personnel to: add and edit lead types, categories, subcategories, keywords, and lead data forms; manage lbs ad campaigns; process business users' requests to add new lead types and/or modify lead qualifications. In addition, LBS administrators have the ability to monitor the performance of advertisers/business user and, publisher accounts, and the lbs application.

Administrators may establish numerous access permissions to limit access to certain administrative options to authorized personnel 1505. For example, an LBS administrator (i.e., an LBS system manager) may assign rights to internal users of the following types: Marketing Manager, Account Manager Sales Manager, Taxonomy Manager, Customer Support, and/or the like. As such, an LBS administrator may login 1515 and may reset/retrieve lost passwords for other users 1510. They may also hand off login and password requests 1520 to LBS system administrators 1522 who may ultimately provide approvals/denials 1525 of account requests. Upon validating user ID/passwords 1530, an LBS administrator may gain access to an interface allowing for the management and generation of reports for the LBS 1535-1580. Management options include: lead type 1535, 1104, 403, 207, keyword 1540, 403, 212, QLL 1545, user 1545, publisher program 1550, partner program 1555, billing 1580, and/or the like management options. Reporting options include: advertiser performance 1560, partner performance 1565, publisher performance 1570, LBS performance, and/or the like reports.

Lead Type Management

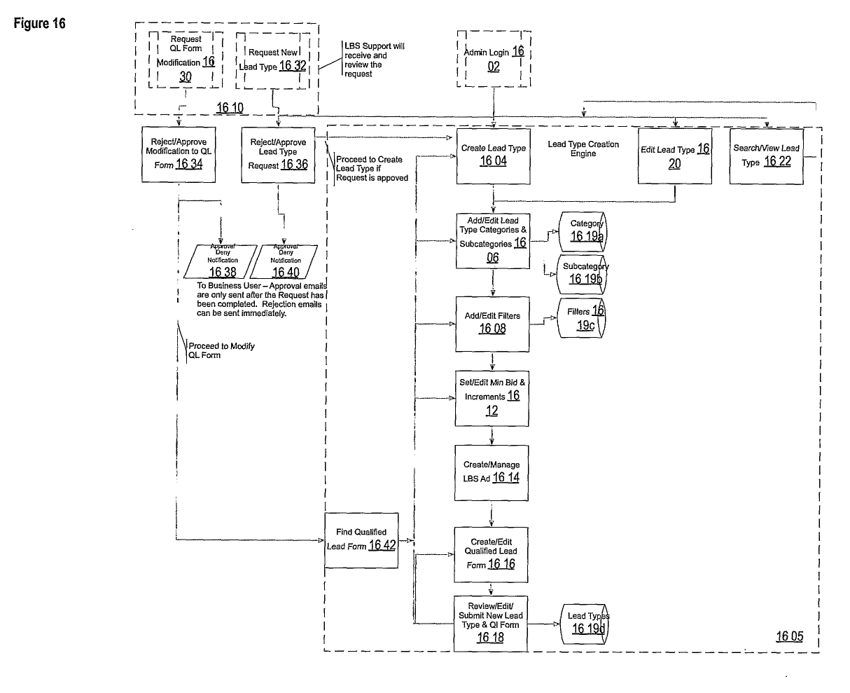

FIG. 16 is of a data-flow block diagram illustrating lead type management. Upon an authorized user logging into the system 1602 and requesting to engage in lead type management 1535, the user will be presented with more options for lead type management in the least type creation engine 1605, which may include: editing lead types 1620, creating lead types 1604 and searching and/or viewing lead types 1622. If the user does not find an appropriate category and/or subcategory the user shall have the ability to create a new category and/or subcategory for the lead type. As has already been discussed at some length in FIGS. 11 and 12, when a user elects to either create 1604 or edit a lead type 1620, the user will be prompted to first add/edit lead type categories and subcategories 1606.

The sub/categories are stored in the LBS database 1619a,b. Upon establishing the appropriate categories, the user may add/edit filters 1608, which also will be stored in the LBS database 1619c. For example, the user may make the following settings:

Lead Type: Home Equity Loan/Filter: State—California

The user may then set/edit minimum bid boundaries and increments 1612, create and manage LBS ads 1614, create and edit qualified leads forms 1616, review/edit/submit new lead types and QL forms 1618 (which would also be stored in the LBS database 1619d), and/or the like.

Additionally, the lead type creation engine 1605 may be accessed by LBS administrators in response to requests by bidders 1610. Upon obtaining requests to modify QL forms 1630 or to create new lead types 1632, administrators may, respectively, reject/approve the requests 1634, 1636 and provide (e.g., email) notification 1638, 1640 to the requesting users. If the request to change and/or add a lead type is approved 1636, the administrative user may proceed to engage the lead type creation engine 1605, 1604 as has been discussed. Similarly, if the request to change and/or add a lead type form is approved 1634, then the lead type creation engine 1605 is engaged by locating a desired qualified lead form 1642 that will act as a basis for edits or a starting point for the creation of a new form 1642; thereafter form creation 1616 and submission 1618 may continue as has already been discussed.

Keyword Management

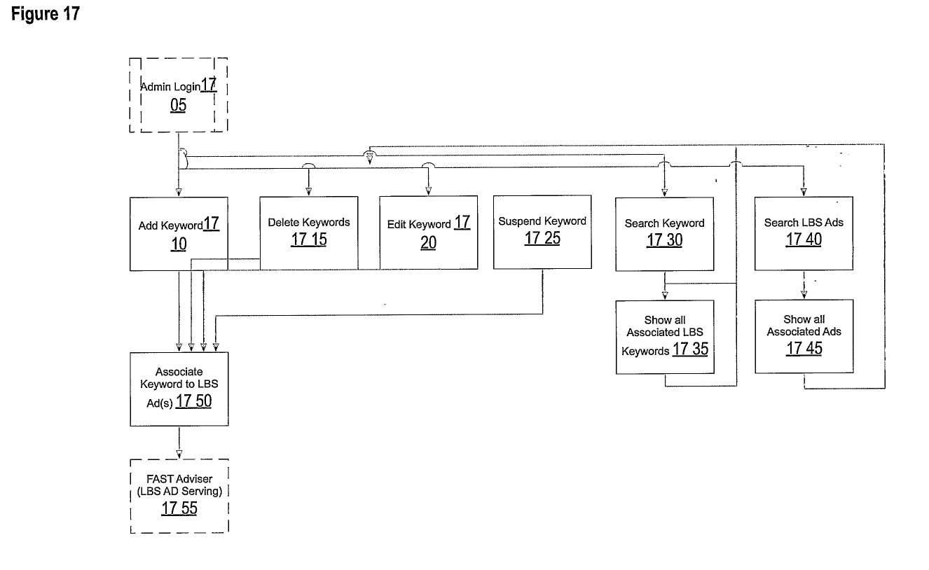

FIG. 17 is of a data-flow block diagram illustrating keyword management. The user has the ability to edit existing keywords, or assign the newly created keywords to an existing lead type, category and/or subcategory. To access the lead type, category and/or subcategory to which the keyword(s) will be assigned, the user may search or browse for the lead type, category and/or subcategory.

Upon an authorized user logging into the system 1705 and requesting to engage in keyword management 1540, the user will be presented with more options for keyword management. When the user selects options (e.g., via web form buttons, popup lists, etc.) to add keywords 1710, delete keywords 1715, edit keywords 1720, suspend keywords 1725, etc., the changes to associations for the affected keywords are affected in the LBS database 1750. Thus, the LBS search facility 110 and ad providing system 130 will dynamically incorporate the use of the modified and/or newly (dis)associated keywords while serving ads 1755. The user may also search for keywords by entering a phrase 1730 and retrieving matching keywords from the LBS database 1735; the user may then select the keywords and further manage them 1710, 1715, 1725, 1740. Similarly, the user may also search for LBS ads by entering a phrase 1740 and retrieving matching ads from the LBS database 1745; the user may then select the ads and further manage them 1710, 1715, 1725, 1740.

QLL and User Management

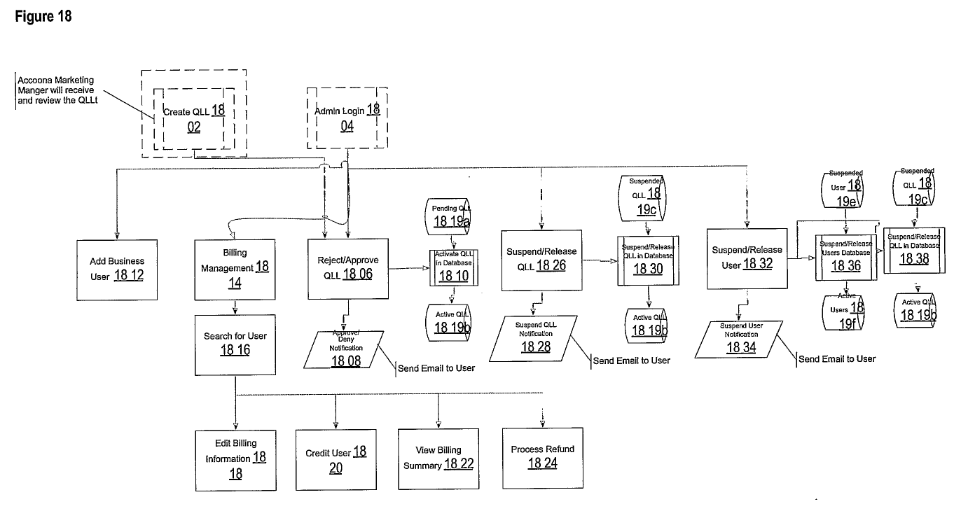

FIG. 18 is of a data-flow block diagram illustrating qualified lead list and user management. Upon an authorized user logging into the system 1804 and requesting to engage in qualified lead list and user management 1545, the user will be presented with more options for management, which may include: add a user 1812, billing management 1814, reject/approve QLL 1806, suspend/release a QLL 1826, suspend/release a user 1832, and/or the like. If the user wishes to engage in bill management 1814, they may search for a user/account 1816, make any selections from among a matching list of users, and then manage that user with the following options: edit billing information 1818, credit the user 1820, view a billing summary 1822, and process refunds 1824. It should be noted that when administrators (e.g., LBS marketing managers) receive and review QLLs, or are otherwise in the process of creating a QLL 1802 (see FIG. 11), they may also engage in QLL and user management 1545; i.e., they, or other authorized administrators 1804, may reject/approve QLLs 1806. Upon approval/denial of the QLL request, a notification is sent to the user 1808. If approved, the QLL is sent to the LBS database 1810 where it is either placed in a pending table 1819a or active QLL table 1819b that may be used by the bid and bill facility 130 to match bids to leads. Similarly, administrative users may suspend/release QLLs 1826. Upon suspending/releasing of a QLL, a notification is sent to the user 1828. The suspended/released QLL is sent to the LBS database 1830 where it is either placed in a suspended table 1819c or active QLL table 1819b that may be used by the bid and bill facility 130 to match bids to leads. The process is similar with regard to users. Administrative users may suspend/release users (e.g., bidders) 1832. Upon suspending/releasing of a bidder's account, a notification is sent to the bidder 1834. The suspended/released user account is modified at the LBS database 1836 where it is either placed in a suspended user table 1819e or active users table 1819f. If a user account status changes, it may affect all of the accounts pending QLLs, and as such, the suspending/releasing of the user account will likewise cause the suspending/release of the accounts related QLLs in the LBS database 1838; i.e., causing related QLLs to either be placed in the suspended database table 1819c or active QLL database table 1819b.

### Bid and Billing Facility

FIG. 19 is of a logic-flow diagram illustrating a bid and billing facility. A bid and billing facility holds biddings where bidders compete against one another to win leads to consumer interest. In one embodiment, bidding is a process by which 4 (or fewer) advertisers are awarded lead data based upon matched criteria with the highest bid amount. Each bidding occurs at the lead data product item level and is defined as a unique combination of lead type, filter, target country and data level. An example might be: Lead Type=New Car Purchase; Filter=Honda; Data Level=Basic; Target Country=United States.

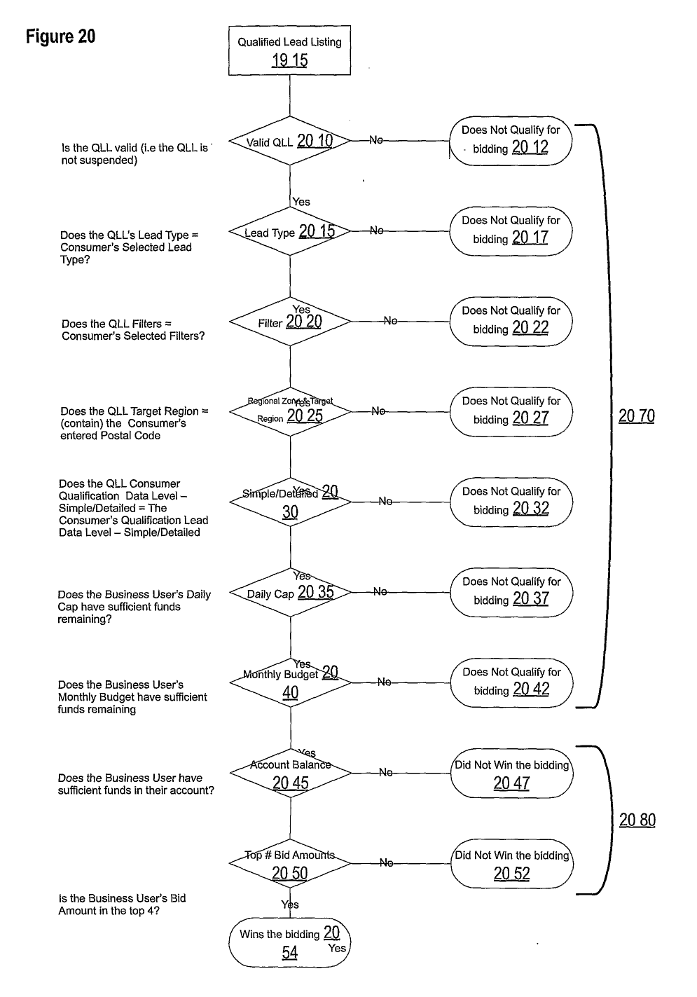

In one embodiment, the bid and billing facility obtains qualified lead listing forms 1905 from bidder, as has already been discussed in detail in previous figures. The bid and billing facility also receives consumer qualified leads 1910, as has already been discussed in detail in previous figures. The bid and billing facility then determines which advertisers are eligible to participate in the bidding for each lead 1915 (see FIG. 20 for greater detail). This may be achieved by examining the tag types of each lead and using that as a basis for a selection query on qualified lead listings. Once the best matching qualified lead listing (i.e., bid participants) types are identified 1915, bidding takes place as amongst the plurality of bidders for a given lead of matching type 1920.

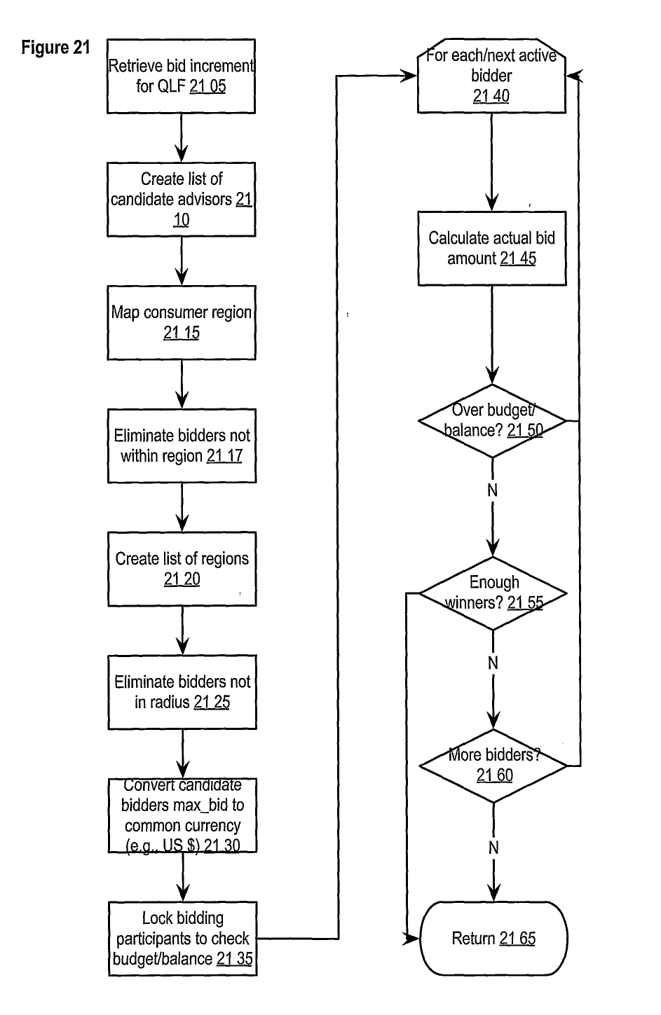

Depending on the type of lead being bidded on, the rules for determining winners 1925 may vary. For example, if the lead is of a kind that can only be exploited by one bidder, i.e., and exclusive, then the number of winning bids will be limited to just one. Other lead types may have semi-exclusive and non-exclusive requirements. In this way, the bid and billing facility will employ a lead's lead type in establishing the context of determining winners 1925. When winners are determined (see FIG. 21 for greater detail) 1925, each winning bidder's accounts and reports are updated 1930. The LBS is also updated to make note that the lead is no longer active and reports may be generated 1935. At this point, a confirmation page (i.e., a page of ads from the winning bidders) may be displayed to the consumer 1940. Upon the completion of the bidding, the following bidding information would be recorded and stored in the LBS database.
Unique Bidding Id
Date & Time stamp of the bidding
Lead Type
Filter/Answer (if applicable)
Target Country Region
POAP Ad
Number of participates in the bidding (winners and losers)
Winner's Participants' Account Numbers (1 thru 4)
Winners' Participants' User's IDs (email address)
Winners' Participants' Name (First & Last)
Winners' Participants' Company Name
Winning Bid amount (amount charged) for each winner
Maximum bid amounts for each winner participant.
Participants' Rank (1 thru 4 denotes winners)
Ad origin (publisher id)
Status of bid (reason for losing—over daily budget, over monthly budget, over account balance)

The winning bidders may then be notified of their winning bids 1950. The consumer lead data may then be provided to the winning bidders who may then follow-up on the lead in a number of different ways (e.g., via email, telephone, IM, SMS, facsimile, in person, etc.) 1955.

It should be noted that while leads may be used by winning bidders, they may not be fully exploited and may be recycled. For example, if a single exclusive lead is provided to a winning bidder, and that bidder is not able to convert the lead, that lead may be reactivated after a specified amount of time and put back into the pool of available leads. Leads may have general life expectancies, depending on lead types, and be automatically cleared from the LBS after they become stale. Also, recycled leads maybe offered at discounts or premiums when placed back in the pool of available leads. For example, if a lead indicates a consumer must purchase car insurance by a certain time (or otherwise they will be breaking the law of their state) and a first group of bid winners did not convert on the lead, arguably, that lead may have become more valuable as the consumer has less time in which to secure their insurance. For leads that have no winning bids, they may be provided to a sales manager 1945 for review of their value.

FIG. 20 is of a logic-flow diagram illustrating a bidder participation determination. In one embodiment, bidder's supplied QLL, i.e., bid proposals, must satisfy a series of criteria to participate in bidding (i.e., and ultimately win the bidding). If any of the criteria are not satisfied, then the QLL will either not qualify for the bidding 2070 or will not win the bidding 2080. As such, the bid and billing facility 130 will check if the QLL is valid 2010 making sure it is not suspended, stale, or otherwise cancelled or unavailable. If it is valid, the facility determines if the QLL's lead type is the consumer's selected (e.g., from the qualified lead form) lead type 2015. If it is, the facility determines if the QLL's filters match the consumer's selected filters 2020. If the filters match, the facility determines if the QLL's target region contains the consumer's region. For example, if the consumer wanted to buy a car within 10 miles of their zip code, but the QLL was not specified for that region, there would be a region mismatch. In one embodiment this is achieved by using geocodes. A consumer's address and or zip code may establish a geocode area (e.g., employing GIS databases, and/or the like), and so would the regional specification made by the bidder 2025. If the geocode areas overlap, then the regions match. If the consumer is in the bidders regional target zone, then the facility may determine if the detail level of the provided lead matches the detail requirements of the bidders QLL 2030. For example, if a QLL specifies that it requires detailed leads and the user only provided a basic lead, then there would be a mismatch. If the detail levels match, the facility may determine if the bidder has reached their daily bidding cap 2035. If the daily cap has not been exhausted, the facility will check if any other budgets (e.g., campaign, monthly, etc.) have been exceeded 2040. If the budgets have not been exceeded, then the bidder's QLL may finally participate in the bidding. However, if the bidder does not have a sufficient account balance 2045, of the account is otherwise in arrears 2045, the bidder will not win the bidding 2047. Based on the lead type, the top number of winning bids 2050 will win the bidding 2054.

QLL Formula

FIG. 21 is of a logic-flow diagram illustrating a bidder determination. In one embodiment, the determination of winners may be viewed as having the following formula:

QLL=Lead_Type+Lead_Data_Level(basic/detailed)+(Filter X+Answer Y)+Region

In evaluating the formula and determining winning bidders 1925, the facility begins by retrieving a bid increment associated with the qualified lead form that was the basis of a consumer's lead submission 2105. Various QLLs may have numerous attributes, lead types, etc., which can specify what the minimum/maximum bid increments are for that lead type. Any of these attributes may be stored and retrieved from LBS database.

Next, the facility creates a list of all candidate bidders on the basis of Lead_Type+Lead_Data_Level (basic/detailed)+(Filter X+Answer Y) 2110. In short, the facility may use the lead's lead type attributes as a basis of a query for QLLs, i.e., qualifying bidders, that have matching lead types. In addition, the level of lead data may act as a requirement to match bidders to leads. In addition, the QLL's filter specifications X are matched to filter answers provided by the qualified lead form answers Y. For example, if a form answer specified that a consumer “hated cruises” then a QLL's filter question for consumers that do not hate cruises would constitute a filter mismatch. These matching criteria were discussed in greater detail FIGS. 19 and 20.

In one embodiment, the facility may then map a consumer region (e.g., zip code, country, state, RMA/DMA, etc.) 2115. The facility may determine the consumer's region via information supplied via the QLL 2115. Upon having mapped the consumers to a region, bidders not in the consumer's region are excluded 2117. It should be noted that bidders may specify their region as being global, national, or other than where they are physically situated.

The facility will create a list of zip codes within a radius of a consumer supplied zip code as a way of establishing a consumer region 2120. Depending on the QLL's filter and/or regional settings, various radii may be used in generating the list of compatible zip codes (e.g., 1, 2, 5, 10, 20, 25, 50, 100, etc. miles). In one embodiment, geographic information system based data may be used to generate the list of zip codes. Also, the consumer may provide filter and/or regional responses that provide geographic constraints (e.g., Chinese food within 5 blocks of the consumer's address). In other words, the facility checks whether the consumer zip code is in the range of an advertiser zip radius. Although the facility may recursively check on each advertiser, such an approach may be CPU/IO consuming as it will depend on the number of advertisers for a given QLL. The above noted approach is more predictable, as the consumer zip radius may be computed and then check if the advertisers' zip codes are within this range. Those advertisers not within range are eliminated 2125.

The facility will convert candidate advertisers' maximum bid to a common currency (e.g., US dollar) and sort by converted max_bids in descending order 2130. This allows the bid and billing facility to rank bids from a plurality of regions. The participating bidder's accounts are then locked and their budgets/balances are checked 2135. The bidders are locked from participating concurrently in another bidding during budget calculations. The locking mechanism ensures that the user is not over his/her budget or balance when he/she participates in another bidding concurrently.

The facility will then evaluate each active bidder 2140. In so doing, the facility will calculate the actual bid amount proposed by the bidder's QLL 2145. The facility then determines if the bidder's accounts are over budget and if the account has proper monetary balances 2150. If so, the bidder is added to the winners list and the facility determines if it has enough winners for the lead 2155. For example, in a semi-exclusive bidding round, perhaps there should be only 2 winning bids. In such a case, once two of the highest bidders are found, the bidding would end 2165. If there are not enough winning bidders 2155, the facility will check and see if there are any more bidders 2160. If there are no more bidders, the bidding will end 2165, otherwise the facility will evaluate the next bidder 2140.

Example QLL Formula Evaluations

The following tables show example embodiments of the evaluation of QLL formula.

Non regional component evaluation of QLL formula:

| Qualified Lead | To participate in the bidding the Business | |
|---|---|---|
| Listing | User's Qualified Lead List Must meet the | |
| Components | following Criteria | Notes |
| Suspended/Pending | The Business User's Account or QLL has not | The User's account or |
| QLL/Account | been flagged by LBS System Manager as | QLL may be flagged as |
| | suspended or is in the process of being | suspended if the Terms |
| | reviewed for initial approval | & Conditions have |
| | | been violated by the |
| | | business user |
| Active/Hold | The Business User Qualified Lead Listing is | The status is managed |
| QLL | turned “on” or is considered “Active” | by the Business User. |
| Lead Type | Lead Type of the QLL must equal the Lead | |
| | Type associated with the Consumer | |
| | Qualification Form. | |
| Filter | The QLL Filter must equal the filter selected | Filters are selected by |
| | by the Consumer. | the Consumer while |
| | | completing the lead |
| | | form. Not all Lead |
| | | Types will have filters - |
| | | “All” will provide a |
| | | placeholder |
| Target Region | The QLL and Target Region must correspond | |
| | to the Consumer's regional selection (i.e. | |
| | Postal Code, country) | |
| Consumer | The QLL Data Level must equal Consumer's | The Consumer |
| Qualification | selected Level | Qualification Data- |
| Data- | | Basic/Detailed will be |
| Basic/Detailed | | determined by the data |
| | | that is provided by the |
| | | Consumer on the Lead |
| | | Data Form. |
| Daily Cap | The Daily cap has not been achieved. In order | A daily budget begins |
| | to remain eligible for bidding, the Bidder's | at 00:00:00 ET and |
| | Daily Remaining Cap must be greater than or | shall expire at |
| | equal to the greater of the Maximum Bid | 23:59:59 ET. |
| | Amount. | |
| Remaining | Remaining Monthly Balance has not been | A monthly budget |
| Monthly | depleted. In order to remain eligible for an | shall begin at 00:00:00 |
| Balance | bidding the Bidder's Remaining Monthly | ET on the first day of |
| | Balance must be greater than or equal to the | each calendar month |
| | maximum bid amount. | and shall expire at |
| | | 23:59:59 on the last |
| | | day of each calendar |
| | | month. |

Regional (e.g., North America, Europe, Global) component evaluation of QLL formula. Regional areas can be a country, province, state, postal code, demographic area, metropolitan market area, and/or the like.

Billing

The LBS allows for a number of billing embodiments. In one embodiment, the bidders will be billed on a monthly cycle. All leads sold to the user during the month will be debited against one charge (per currency) that will be place on the user's credit card at the beginning or at the end of each month. Charges will be processed on a per currency basis. Business User will be notified of account depletion and will have the option to replenish the account. The user shall also be able to log into the business user account management system and view a history of their transactions. A number of other billing options follow:

Post-Pay Option: The post-pay option must be approved and setup by an LBS administrator. If the post-pay option is requested and setup by an LBS Administrator the user shall be charged at the end of each month for leads awarded over the course of the month.

Pre-Pay Option: If the pre-pay option is selected, the user shall be given the option for automatic replenishment. If the pre-pay option is selected, the user will have an account balance that is decremented when lead data is awarded. The initial account balance will be defined as the result of a charge against a customer's credit card and shall be an amount greater than or equal to the defined monthly cap. When the user's account balance is low (prohibiting eligibility in at least 1 bidding), the user will be notified of the low account balance. The user has the option to manage his/her account balance or agree to automatic replenishment. The user has the ability to add money to his/her account balance at any time.

Automatic Replenishment: Automatic replenishment amount is a fixed amount defined by the user that will be greater than or equal to the defined monthly cap. Automatic replenishment will occur on the first of the month. Automatic replenishment triggers a transaction against the user's credit card if the account balance is less than 70% (TBD) of the identified replenishment amount. Automatic replenishment will trigger a transaction in which the amount charged equals the pre-defined replenishment amount less the current account balance.

User Initiated Replenishment: A business user has the option to add to his/her account balance at any given time. The business may indicate that he/she would like to add money to his/her account balance and shall specify the amount to add. The business user is asked if he/she would like to adjust the monthly cap for the account/QLLs (depending upon account setup) and will be directed to the appropriate screen. The business user has the option to adjust the remaining balance for the current month for the account/QLLs (depending on account setup). The user can add to his/her account balance without adjusting the monthly cap or remaining monthly balance.

Billing Reporting: Upon the completion of bidding, the following billing information shall be recorded and stored in the LBS database for each bidding winner:
Bidding ID (same as in bidding log)
Bidding Time Stamp
Business User Account Number
Business User Name (First & Last)
Business User Company
Winning Bid Amount
Bidding Position Rank (i.e. 1st, 2nd, 3rd or 4th)

Revenue Reporting: The user can select a time frame in which to run a revenue report. (e.g., from May 1, 2005 to Aug. 19, 2005).

The following revenue information shall be included in the revenue report:
Total Number of Biddings
Total Amount to charged
Total Number of Refunds
Total Refund Amount
Net Amount (Billed-Refunds)

The reports may be provided at regular intervals (e.g., Daily Report, Weekly Report, Monthly Report, Yearly Report) for example, via cron job initiation. Similarly, billing reports may be run as well.

### Lead Bidding System Controller

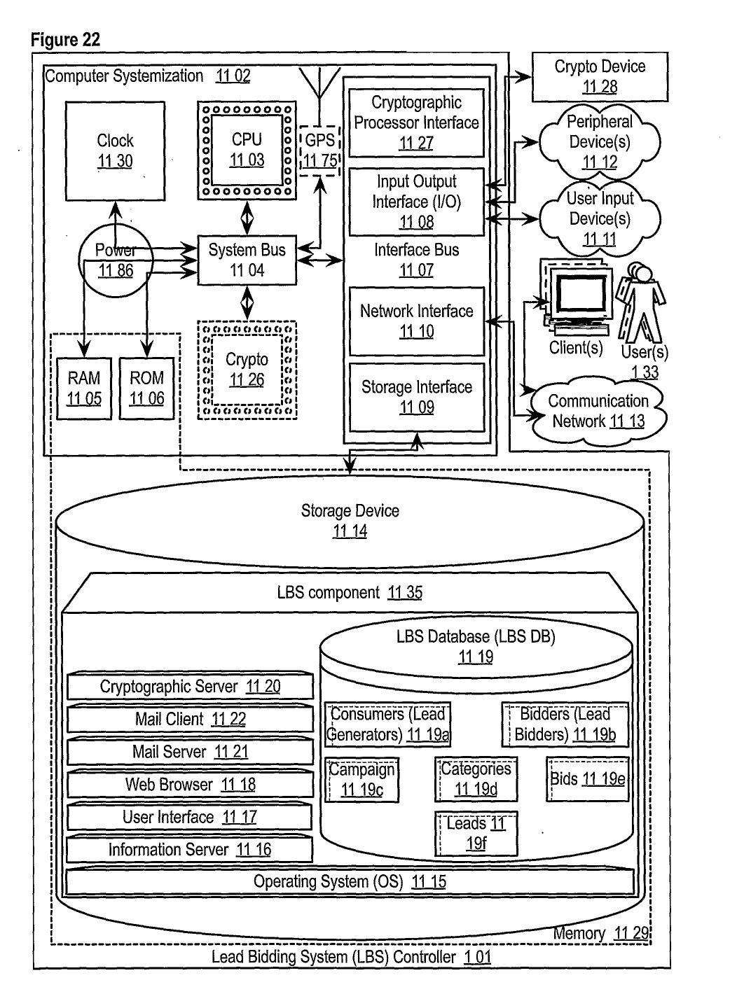

FIG. 22 of the present disclosure illustrates inventive aspects of a lead bidding system controller 2201 in a block diagram. In this embodiment, the lead bidding system controller 2201 may serve to aggregate, process, store, search, serve, identify, instruct, generate, match, and/or update bids, leads, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the lead bidding system controller 2201 may be connected to and/or communicate with entities such as, but not limited to: one or more users from user input devices 2211; peripheral devices 2212; a cryptographic processor device 2228; and/or a communications network 2213.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The lead bidding system controller 2201 may be based on common computer systems that may comprise, but are not limited to, components such as: a computer systemization 2202 connected to memory 2229.

Computer Systemization

A computer systemization 2202 may comprise a clock 2230, central processing unit (CPU) 2203, a read only memory (ROM) 2206, a random access memory (RAM) 2205, and/or an interface bus 2207, and most frequently, although not necessarily, are all interconnected and/or communicating through a system bus 2204. Optionally, the computer systemization may be connected to an internal power source 2286. Optionally, a cryptographic processor 2226 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the lead bidding system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 2286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2286 is connected to at least one of the interconnected subsequent components of the lead bidding system thereby providing an electric current to all subsequent components. In one example, the power source 2286 is connected to the system bus component 2204. In an alternative embodiment, an outside power source 2286 is provided through a connection across the I/O 2208 interface. For example, a USB and/or IEEE 1394 connection carries both data and power across the connection and is therefore a suitable source of power.

Interface Adapters

Interface bus(ses) 2207 may accept, connect, and/or communicate to a number of interface adapters, conventionally although not necessarily in the form of adapter cards, such as but not limited to: input output interfaces (I/O) 2208, storage interfaces 2209, network interfaces 2210, and/or the like. Optionally, cryptographic processor interfaces 2227 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2209 may accept, communicate, and/or connect to a number of storage devices such as, but not limited to: storage devices 2214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2210 may accept, communicate, and/or connect to a communications network 2213. Through a communications network 113, the lead bidding system controller is accessible through remote clients 2233b (e.g., computers with web browsers) by users 2233a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2210 may be used to engage with various communications network types 2213. For example, multiple network interfaces may be employed to allow for the communication over broadcast, multicast, and/or unicast networks.

Input Output interfaces (I/O) 2208 may accept, communicate, and/or connect to user input devices 2211, peripheral devices 2212, cryptographic processor devices 2228, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 2211 may be card readers, dongles, finger print readers, gloves, graphics tablets, joysticks, keyboards, mouse (mice), remote controls, retina readers, trackballs, trackpads, and/or the like.

Peripheral devices 2212 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the lead bidding system controller may be embodied as an embedded, dedicated, and/or monitor-less (i.e., headless) device, wherein access would be provided over a network interface connection.

Cryptographic units such as, but not limited to, microcontrollers, processors 2226, interfaces 2227, and/or devices 2228 may be attached, and/or communicate with the lead bidding system controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 2229. However, memory is a fungible technology and resource, thus, any number of memory embodiments may be employed in lieu of or in concert with one another. It is to be understood that the lead bidding system controller and/or a computer systemization may employ various forms of memory 2229. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 2229 will include ROM 2206, RAM 2205, and a storage device 2214. A storage device 2214 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 2229 may contain a collection of program and/or database components and/or data such as, but not limited to: operating system component(s) 2215 (operating system); information server component(s) 2216 (information server); user interface component(s) 2217 (user interface); Web browser component(s) 2218 (Web browser); database(s) 2219; mail server component(s) 2221; mail client component(s) 2222; cryptographic server component(s) 2220 (cryptographic server); the lead bidding system component(s) 2235; and/or the like (i.e., collectively a component collection). These components may be stored and accessed from the storage devices and/or from storage devices accessible through an interface bus. Although non-conventional program components such as those in the component collection, typically, are stored in a local storage device 2214, they may also be loaded and/or stored in memory such as: peripheral devices, RAM, remote storage facilities through a communications network, ROM, various forms of memory, and/or the like.

Operating System

The operating system component 2215 is an executable program component facilitating the operation of the lead bidding system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the lead bidding system controller to communicate with other entities through a communications network 2213. Various communication protocols may be used by the lead bidding system controller as a subcarrier transport mechanism for interaction, such as, but not limited to: multicast, TCP/IP, UDP, unicast, and/or the like.

Information Server

An information server component 2216 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the lead bidding system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the lead bidding system database 2219, operating systems, other program components, user interfaces, Web browsers, and/or the like.

Access to the lead bidding system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Lead bidding system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the lead bidding system as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 2217 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 2218 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the lead bidding system enabled nodes. The combined application may be nugatory on systems employing standard Web browsers.

Mail Server

A mail server component 2221 is a stored program component that is executed by a CPU 2203. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the lead bidding system.

Access to the lead bidding system mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 2222 is a stored program component that is executed by a CPU 2203. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 2220 is a stored program component that is executed by a CPU 2203, cryptographic processor 2226, cryptographic processor interface 2227, cryptographic processor device 2228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the lead bidding system may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the lead bidding system component to engage in secure transactions if so desired. The cryptographic component facilitates the secure accessing of resources on the lead bidding system and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Lead Bidding System Database

The lead bidding system database component 2219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the lead bidding system database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the lead bidding system database is implemented as a data-structure, the use of the lead bidding system database 2219 may be integrated into another component such as the lead bidding system component 2235. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2219 includes several tables 2219a-e. A users table 2219a includes fields such as, but not limited to: a user name, email address, address, profile, user_id, and/or the like. The user table may support and/or track multiple entity accounts on a lead bidding system. An bidders table 2219b includes fields such as, but not limited to: account_id, admin_user_id (a user given administrative status to control the account), account_level, and/or the like. A campaign table 2219c includes fields such as, but not limited to: campaign_id, account_id, category_id, and/or the like. A categories table 2219d includes fields such as, but not limited to: category_id, sub_category, and/or the like. A bids table 119e includes fields such as, but not limited to: search_id, search information, user_id, category_id, campaign_id, and/or the like. Appendices 1-13 show an alternative embodiment of the LBS database as a series of entity-relationship diagrams.

In one embodiment, the lead bidding system database may interact with other database systems. For example, employing a distributed database system, queries and data access by OLBS modules may treat the combination of the lead bidding system database, an integrated data security layer database as a single database entity.

In one embodiment, user programs may contain various user interface primitives, which may serve to update the lead bidding system. Also, various accounts may require custom database tables depending upon the environments and the types of clients the lead bidding system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2219a-e. The lead bidding system may be configured to keep track of various settings, inputs, and parameters via database controllers.

The lead bidding system database may communicate to and/or with other components in a component collection, including itself, and/or facilities of the like. Most frequently, the lead bidding system database communicates with the lead bidding system component, other program components, and/or the like. The database may contain, retain, and provide information regarding other nodes and data.

The Lead Bidding System

The lead bidding system component 2235 is a stored program component that is executed by a CPU. The lead bidding system affects accessing, obtaining and the provision of information, services, transactions, and/or the like across various communications networks.

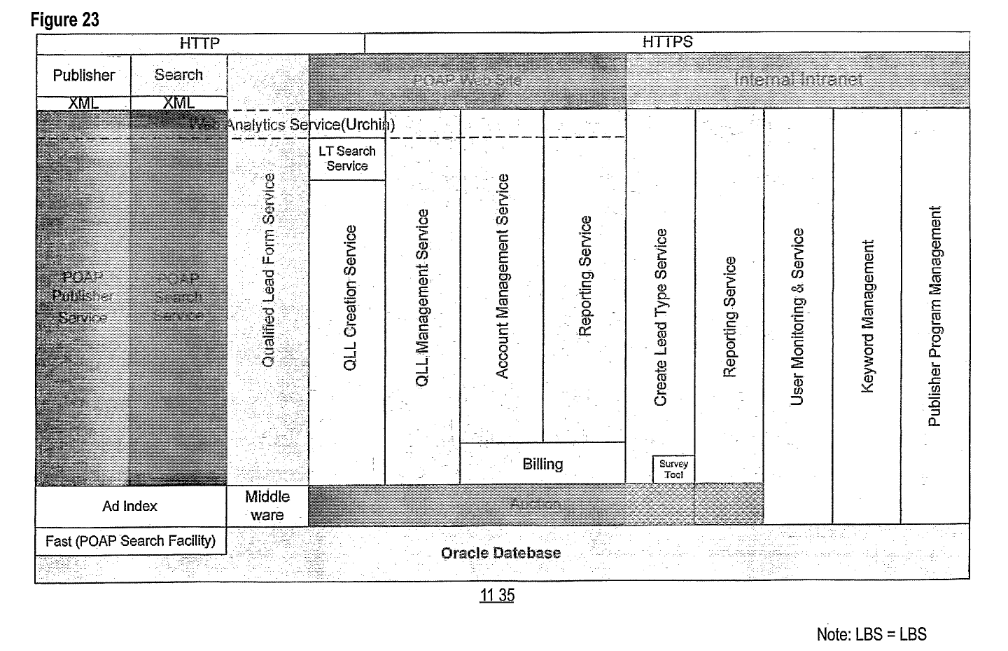

The lead bidding system component enables the identification, generation, and aggregation of leads and bids on leads. FIG. 23 shows an alternative embodiment and arrangement of the lead bidding component.

The lead bidding system component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the lead bidding system server employs a cryptographic server to encrypt and decrypt communications. The lead bidding system component may communicate to and/or with other components in a component collection, including itself, and/or facilities of the like. Most frequently, the lead bidding system component communicates with the lead bidding system database, operating systems, other program components, and/or the like. The lead bidding system may contain, communicate, generate, obtain, and/or provide program component, system, user, and/or data communications, requests, and/or responses.

Distributed Lead Bidding System

The structure and/or operation of any of the lead bidding system node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the lead bidding system controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1. A processor-implemented method to bid on indications of interest, comprising:
obtaining a search query from a searcher;
finding keywords in a search ontology with terms from the search query;
searching a database for advertisements responsive to the search query, wherein the search for advertisements uses both the search query and found keywords;
providing the searcher with a search response responsive to the search query; wherein the search response includes at least one invokeable indicator of interest that is invokeable by the searcher, wherein the interest indicator is an advertisement responsive to the search query;
obtaining an indication of interest in response to interaction with the interest indicator from the search response, wherein the interest indication is a searcher selection;
providing a form to obtain additional indication of interest in response to the interest indication by the searcher, wherein the form is structured to obtain identifying information;
obtaining the additional interest indication from form entries, wherein the additional interest indication is a searcher selection, wherein the additional interest indication includes identifying information,
wherein the identifying information includes a personal identifier,
wherein the personal identifier includes contact information,
wherein the contact information includes an email address, verifying any obtained searcher interest information for validity;
storing any of the searcher interest information; submitting any of the searcher interest information for bidding;
obtaining bids from bidders interested in the searcher interest information;
determining candidate bids for bidding by comparing bid parameters to searcher interest information, wherein comparison is made on the basis of: types of interest information, level of detail of interest information, filtering criteria, and regional limitations;
selecting at least one winning bid from the candidate bids, wherein candidate bids having highest values are selected;
providing the searcher interest information to at least one of the bidders whose bid was selected as a winning bid; providing the searcher with ads from the winning bidder; and
charging the winning bidder for the provision of the searcher interest information.

2. A processor-implemented method to bid on indications of interest, comprising:
obtaining a search query from a searcher; searching a database for advertisements responsive to the search query;
providing the searcher with a search response responsive to the search query, wherein the search response contains at least one interest indicator;
obtaining an indication of interest in response to interaction with the interest indicator from the search response;
obtaining bids from bidders interested in the searcher interest indication; selecting at least one winning bid from the obtained candidate bids;
providing the searcher interest indication to at least one of the bidders whose hid was selected as a winning bid.

3. A processor-implemented method to bid on indications of interest, comprising:
obtaining a search query from a searcher; searching a database for advertisements responsive to the search query;
providing the searcher with a search response responsive to the search query, wherein the search response contains at least one interest indicator;
obtaining an indication of interest in response to interaction with the interest indicator from the search response.

4. The method of claim 3, further, comprising: finding keywords in a search ontology with terms from the search query.

5. The method of claim 4, wherein the search for advertisements uses the search query.

6. The method of claim 4, wherein the search for advertisements use the found keywords.

7. The method of claim 4, wherein the search for advertisements uses both the search query and found keywords.

8. The method of claim 3, wherein the search response includes at least one invokeable indicator of interest that is invokeable by the searcher.

9. The method of claim 8, wherein the interest indicator is search results responsive to the search query.

10. The method of claim 8, wherein the interest indicator is an advertisement responsive to the search query.

11. The method of claim 8, wherein the interest indicator is a navigable arrangement of topics.

12. The method of claim 11, wherein the arrangement of topics is responsive to the search query.

13. The method of claim 11, wherein the navigable arrangement of topics are hyperlinks.

14. The method of claim 11, wherein the arrangement of topics allows for topic selections on goods and services.

15. The method of claim 11, wherein the navigable arrangement of topics are arranged by category.

16. The method of claim 15, wherein the categories are navigable to subcategories.

17. The method of claim 8, wherein the interest indicator is a form that allows the searcher to provide identifying information.

18. The method of claim 11, wherein identifying information from a stored profile is used to populate the form.

19. The method of claim 17, wherein the form is provided in response to the searcher interaction with the interest indicator.

20. The method of claim 17, wherein the form is structured to obtain basic personal identifying information.

21. The method of claim 17, wherein the form is structured to obtain detailed personal identifying information.

22. The method of claim 17, wherein the form allows for specification of goods and services.

23. The method of claim 17, wherein the form allows for specification of an interest type.

24. The method of claim 17, wherein the form allows for specification of an interest type segment.

25. The method of claim 17, wherein the form allows for specification demographic indicia.

26. The method of claim 17, wherein the form allows for specification of a category.

27. The method of claim 17, wherein the form allows for specification of a subcategory.

28. The method of claim 17, wherein the form allows for specification of a region.

29. The method of claim 17, wherein the form allows for specification of filtering limitations.

30. The method of claim 29, wherein the filtering limitations are of a brand.

31. The method of claim 3, wherein the interest indication is information from a form.

32. The method of claim 3, wherein the interest indication includes interest indication about consumer goods and services.

33. The method of claim 3, wherein the interest indication includes interest indication about a topic.

34. The method of claim 3, wherein the interest indication includes interest indication about an interest type.

35. The method of claim 3, wherein the interest indication includes interest indication about an interest type segment.

36. The method of claim 3, wherein the interest indication includes interest indication about demographic indicia.

37. The method of claim 3, wherein the interest indication includes interest indication about a category.

38. The method of claim 3, wherein the interest indication includes interest indication about a subcategory.

39. The method of claim 3, wherein the interest indication includes interest indication about a region.

40. The method of claim 3, wherein the interest indication is a searcher selection.

41. The method of claim 40, wherein the searcher selection is a click.

42. The method of claim 3, wherein the interest indication includes filtering limitations.

43. The method of claim 42, wherein the filtering limitations are of a brand.

44. The method of claim 3, wherein the interest indication includes identifying information.

45. The method of claim 44, wherein identifying information from a stored profile is used to populate a form.

46. The method of claim 44, wherein at least part of the identifying information is obtained from a stored profile.

47. The method of claim 46, wherein the stored profile is stored as a cookie on the searcher's computer.

48. The method of claim 44, wherein the identifying information includes a personal identifier.

49. The method of claim 48, wherein the personal identifier includes an IP address.

50. The method of claim 48, wherein the personal identifier includes a social security number.

51. The method of claim 48, wherein the personal identifier includes a drivers license number.

52. The method of claim 48, wherein the personal identifier includes financial information.

53. The method of claim 52, wherein the financial information includes a credit card number.

54. The method of claim 52, wherein the financial information includes a bank account number.

55. The method of claim 48, wherein the personal identifier includes contact information.

56. The method of claim 55, wherein the contact information includes an email address.

57. The method of claim 55, wherein the contact information includes a telephone number.

58. The method of claim 55, wherein the contact information includes an address.

59. The method of claim 55, wherein the contact information includes an instant messenger identifier.

60. The method of claim 3, further, comprising: providing a form to obtain additional indication of interest in response to an interest indication by the searcher.

61. The method of claim 60, wherein the contact information includes an instant messenger identifier.

62. The method of claim 60, wherein the form is structured to obtain identifying information.

63. The method of claim 60, wherein the form is structured to obtain basic personal identifying information.

64. The method of claim 60, wherein the form is structured to obtain detailed personal identifying information.

65. The method of claim 60, wherein the form allows for specification of goods and services.

66. The method of claim 60, wherein the form allows for specification of a category.

67. The method of claim 60, wherein the form allows for specification of a subcategory.

68. The method of claim 60, wherein the form allows for specification of a region.

69. The method of claim 60, wherein the form allows for specification of filtering limitations.

70. The method of claim 69, wherein the filtering limitations are of a brand.

71. The method of claim 60, further, comprising: obtaining the additional interest indication from form entries.

72. The method of claim 71, wherein the additional interest indication is a searcher selection.

73. The method of claim 71, wherein the additional interest indication includes additional interest indication about consumer goods and services.

74. The method of claim 71, wherein the additional interest indication includes additional interest indication about a topic.

75. The method of claim 71, wherein the additional interest indication includes additional interest indication about an interest type.

76. The method of claim 71, wherein the additional interest indication includes additional interest indication about an interest type segment.

77. The method of claim 71, wherein the additional interest indication includes additional interest indication about demographic indicia.

78. The method of claim 71, wherein the additional interest indication includes additional interest indication about a category.

79. The method of claim 71, wherein the additional interest indication includes additional interest indication about a subcategory.

80. The method of claim 71, wherein the additional interest indication includes additional interest indication about a region.

81. The method of claim 71, wherein the additional interest indication includes filtering limitations.

82. The method of claim 81, wherein the filtering limitations are of a brand.

83. The method of claim 71, wherein the additional interest indication includes identifying information.

84. The method of claim 83, wherein at least part of the identifying information is obtained from a stored profile.

85. The method of claim 84, wherein the stored profile is stored as a cookie on the searcher's computer.

86. The method of claim 83, wherein identifying information from a stored profile is used to populate a form.

87. The method of claim 83, wherein the identifying information includes a personal identifier.

88. The method of claim 87, wherein the personal identifier includes an IP address.

89. The method of claim 87, wherein the personal identifier includes a digital object identifier.

90. The method of claim 87, wherein the personal identifier includes a social security number.

91. The method of claim 87, wherein the personal identifier includes a drivers license number.

92. The method of claim 87, wherein the personal identifier includes financial information.

93. The method of claim 92, wherein the financial information includes a credit card number.

94. The method of claim 92, wherein the financial information includes a hank account number.

95. The method of claim 87, wherein the personal identifier includes contact information.

96. The method of claim 95, wherein the contact information includes an email address.

97. The method of claim 95, wherein the contact information includes a telephone number.

98. The method of claim 95, wherein the contact information includes an address.

99. The method of claim 95, wherein the contact information includes an instant messenger identifier.

100. The method of claim 3, further, comprising: verifying any obtained searcher interest information for validity.

101. The method of claim 100, further, comprising: resolving regional information based on supplied searcher identifying information, wherein the searcher's IP address is used to determine a searcher region, and wherein the searcher's IP address is used to verify the searcher interest information.

102. The method of claim 3, further, comprising: storing any of the searcher interest information.

103. The method of claim 3, further, comprising: submitting any searcher interest information for bidding.

104. The method of claim 3, further, comprising: obtaining bids from bidders interested in the searcher interest information.

105. The method of claim 3, further, comprising: determining candidate bids for bidding by comparing bid parameters to searcher interest information.

106. The method of claim 105, wherein comparison is made on the basis of: types of interest information, level of detail of interest information, filtering criteria, and regional limitations.

107. The method of claim 3, further, comprising: selecting at least one winning bid from the candidate bids.

108. The method of claim 107, wherein candidate bids having highest values are selected.

109. The method of claim 107, wherein a determination of how many winning bids are selected is based on the type of searcher interest information being bid upon.

110. The method of claim 107, wherein the searcher interest information is awarded exclusively to a single winning bidder.

111. The method of claim 107, wherein the searcher information is awarded semi-exclusively to a small number of winning bidders.

112. The method of claim 107, wherein the searcher information is awarded non-exclusively to all candidate bidders.

113. The method of claim 3, further, comprising: providing the searcher interest information to at least one of the bidders whose bid was selected as a winning bid.

114. The method of claim 113, wherein the searcher information includes contact information for the searcher.

115. The method of claim 3, further, comprising: providing the searcher with ads from the winning bidder.

116. The method of claim 3, further, comprising: charging the winning bidder for the provision of the searcher interest information.

117. A processor-implemented method to bid on indications of interest, comprising:
obtaining information from a prospective bidder specifying a desired type of consumer interest indication;
obtaining information from a prospective bidder specifying a desired region; obtaining information from a prospective bidder specifying filters;
obtaining information from a prospective bidder specifying hid values; submitting all obtained information as a qualification request for consumer interest indication;
matching the request for consumer interest indication with submitted consumer interest indications;
determining which of the matched requests for consumer interest indication will win a bid for the submitted consumer interest indication;
selecting winning bidders from the determined winning bids with highest values;
providing the consumer interest indication to the winning bidders.

118. A processor-implemented method to bid on indications of interest, comprising:
obtaining information from a prospective bidder specifying a desired type of consumer interest indication;
obtaining information from a prospective bidder specifying bid values;
submitting the obtained information as a qualification request for consumer interest indication;
matching the request for consumer interest indication with submitted consumer interest indications;
determining which of the matched requests for consumer interest indication will win a bid for the submitted consumer interest indication;
selecting winning bidders from the determined winning bids, wherein the winning bidders are selected from bidding criteria;
providing the consumer interest indication to the winning bidders.

119. The method of claim 118, further, comprising: obtaining information from a prospective bidder specifying a desired region.

120. The method of claim 118, further, comprising:

121. The method of claim 118, wherein the desired type of consumer interest indication are categories.

122. The method of claim 118, wherein the desired type of consumer interest indication are subcategories.

123. The method of claim 118, wherein the desired type of consumer interest indication are type segment.

124. The method of claim 118, further, comprising: obtaining information from a prospective bidder specifying filters.

125. The method of claim 124, wherein the filters are demographic indicia.

126. The method of claim 124, wherein the filters are brands.

127. The method of claim 118, wherein the bid values include bid amounts.

128. The method of claim 118, wherein the bid values include bid increments.

129. The method of claim 118, wherein the bid values include bid caps.

130. The method of claim 118, wherein bidding criteria is to select bids with highest values.

131. The method of claim 118, wherein bidding criteria is to select bidders with highest ratings.

132. The method of claim 118, wherein bidding criteria is to select bidders with highest budgets.

133. The method of claim 118, wherein bidding criteria is to select bids that most closely matched the submitted consumer interest indication.

134. The method of claim 118, wherein the consumer interest indication includes identifying information.

135. The method of claim 134, wherein at least part of the identifying information is obtained from a stored profile.

136. The method of claim 135, wherein the stored profile is stored as a cookie on the searcher's computer.

137. The method of claim 134, wherein the identifying information includes a personal identifier.

138. The method of claim 137, wherein the personal identifier includes an IP address.

139. The method of claim 137, wherein the personal identifier includes a social security number.

140. The method of claim 137, wherein the personal identifier includes a drivers license number.

141. The method of claim 137, wherein the personal identifier includes financial information.

142. The method of claim 141, wherein the financial information includes a credit card number.

143. The method of claim 141, wherein the financial information includes a bank account number.

144. The method of claim 137, wherein the personal identifier includes contact information.

145. The method of claim 144, wherein the contact information includes an email address.

146. The method of claim 144, wherein the contact information includes a telephone number.

147. The method of claim 144, wherein the contact information includes an address.

148. The method of claim 144, wherein the contact information includes an instant messenger identifier.

149. A processor-implemented method to generate a data structure in memory, comprising:
generating instruction signals, wherein the signal states embody a data structure having interrelated data types for:
invoking a field for information from a prospective bidder specifying a desired type of consumer interest indication;
invoking a field for information from a prospective bidder specifying a desired region;
invoking a field for information from a prospective bidder specifying filters;
invoking a field for information from a prospective bidder specifying bid values.

150. A processor-implemented method to generate a data structure in memory, comprising:
generating instruction signals, wherein the signal states embody a data structure having interrelated data types for:
invoking a field for information from a prospective bidder specifying a desired type of consumer interest indication;
invoking a field for information from a prospective bidder specifying bid values.

151. The method of claim 150, further, comprising: invoking a field for information from a prospective bidder specifying a desired region.

152. The method of claim 150, further, comprising: invoking a field for information from a prospective bidder specifying filters.

153. The method of claim 150, wherein the region field may include country, province, state, postal code, demographic area, and metropolitan market area information.

154. The method of claim 150, wherein the consumer interest indication includes interest indication about a category.

155. The method of claim 150, wherein the consumer interest indication includes interest indication about a subcategory.

156. The method of claim 150, wherein the consumer interest indication includes interest indication about a goods and services.

157. The method of claim 150, wherein the consumer interest indication is a consumer selection.

158. The method of claim 150, wherein the interest indication includes filtering limitations.

159. The method of claim 158, wherein the filtering limitations are of a brand.

160. The method of claim 150, wherein the consumer interest indication includes identifying information.

161. The method of claim 150, wherein the hid values include bid amounts.

162. The method of claim 150, wherein the bid values include bid increments.

163. The method of claim 150, wherein the bid values include bid caps.

164. A processor-implemented method to generate an interaction interface in memory, comprising:
generating instruction signals, wherein the interaction interface is responsive to user and system event signals and wherein the instruction signals are issueable by a processor for:
invoking a widget to accept information from a prospective bidder specifying a desired type of consumer interest indication;
invoking a widget to accept information from a prospective bidder specifying a desired region; invoking a widget to accept information from a prospective bidder specifying filters;
invoking a widget to accept information from a prospective bidder specifying bid values.

165. A processor-implemented method to generate an interaction interface in memory, comprising:
generating instruction signals, wherein the interaction interface is responsive to user and system event signals and wherein the instruction signals are issueable by a processor for:
invoking a widget to accept information from a prospective bidder specifying a desired type of consumer interest indication;
invoking a widget to accept information from a prospective bidder specifying bid values.

166. The method of claim 165, further, comprising: invoking a widget to accept information from a prospective bidder specifying a desired region.

167. The method of claim 165, further, comprising: invoking a widget to accept information from a prospective bidder specifying filters.

168. The method of claim 165, wherein the region field may include country, province, state, postal code, demographic area, and metropolitan market area information.

169. The method of claim 165, wherein the consumer interest indication includes interest indication about a category.

170. The method of claim 165, wherein the consumer interest indication includes interest indication about a subcategory.

171. The method of claim 165, wherein the consumer interest indication includes interest indication about a goods and services.

172. The method of claim 165, wherein the consumer interest indication is a consumer selection.

173. The method of claim 165, wherein the interest indication includes filtering limitations.

174. The method of claim 173, wherein the filtering limitations are of a brand.

175. The method of claim 165, wherein the consumer interest indication includes identifying information.

176. The method of claim 165, wherein the bid values include bid amounts.

177. The method of claim 165, wherein the bid values include bid increments.

178. The method of claim 165, wherein the bid values include bid caps.

179. A processor-implemented method to generate a data structure in memory, comprising:
generating instruction signals, wherein the signal states embody a data structure having interrelated data types for:
invoking a field for information from a consumer specifying a desired type of consumer interest indication;
invoking a field for information from a consumer specifying a desired region;
invoking a field for information from a consumer specifying filters.

180. A processor-implemented method to generate a data structure in memory, comprising:
generating instruction signals, wherein the signal states embody a data structure having interrelated data types for:
invoking a field for information from a consumer specifying a desired type of consumer interest indication.

181. The method of claim 180, further, comprising: invoking a field for information from a consumer specifying a desired region.

182. The method of claim 180, further, comprising: invoking a field for information from a consumer specifying filters.

183. The method of claim 180, wherein the region field may include country, province, state, postal code, demographic area, and metropolitan market area information.

184. The method of claim 180, wherein the consumer interest indication includes interest indication about a category.

185. The method of claim 180, wherein the consumer interest indication includes interest indication about a subcategory.

186. The method of claim 180, wherein the consumer interest indication includes interest indication about a goods and services.

187. The method of claim 180, wherein the consumer interest indication is a consumer selection.

188. The method of claim 180, wherein the interest indication includes filtering limitations.

189. The method of claim 188, wherein the filtering limitations are of a brand.

190. The method of claim 180, wherein the consumer interest indication includes identifying information.

191. A processor-implemented method to generate an interaction interface in memory, comprising:
generating instruction signals, wherein the interaction interface is responsive to user and system event signals and wherein the instruction signals are issueable by a processor for:
invoking a widget to accept information from a consumer specifying a desired type of consumer interest indication;
invoking a widget to accept information from a consumer specifying a desired region;
invoking a widget to accept information from a consumer specifying filters;

192. A processor-implemented method to generate an interaction interface in memory, comprising:
generating instruction signals, wherein the interaction interface is responsive to user and system event signals and wherein the instruction signals are issueable by a processor for:
invoking a widget to accept information from a consumer specifying a desired type of consumer interest indication.

193. The method of claim 192, further, comprising: invoking a widget to accept information from a consumer specifying a desired region.

194. The method of claim 192, further, comprising: invoking a widget to accept information from a consumer specifying filters.

195. The method of claim 192, wherein the region field may include country, province, state, postal code, demographic area, and metropolitan market area information.

196. The method of claim 192, wherein the consumer interest indication includes interest indication about a category.

197. The method of claim 192, wherein the consumer interest indication includes interest indication about a subcategory.

198. The method of claim 192, wherein the consumer interest indication includes interest indication about a goods and services.

199. The method of claim 192, wherein the consumer interest indication is a consumer selection.

200. The method of claim 192, wherein the interest indication includes filtering limitations.

201. The method of claim 200, wherein the filtering limitations are of a brand.

202. The method of claim 192, wherein the consumer interest indication includes identifying information.

203. A processor-implemented method to bid on sales leads, comprising:
aggregating searches in articles of commerce, wherein searches for the articles of commerce are collected through a search facility from bid generators; acquiring identifying information from the bid generators, wherein the identifying information may include: email addresses, name, address, telephone numbers, responses to and Web form queries;
generating a lead from the searches and associated acquired information;
accepting bids for the leads from providers of articles of commerce matching the lead search requirements and identifying information; and awarding the leads to winning bids.

204. The method of claim 203, wherein winning bids are awarded exclusively.

205. The method of claim 203, wherein winning bids are awarded semi-exclusively.

206. The method of claim 203, wherein winning bids are awarded non-exclusively.

207. A system to bid on indications of interest, comprising:
means to obtain a search query from a searcher; means to find keywords in a search ontology with terms from the search query;
means to search a database for advertisements responsive to the search query, wherein the search for advertisements uses both the search query and found keywords;
means to provide the searcher with a search response responsive to the search query; wherein the search response includes at least one invokeable indicator of interest that is invokeable by the searcher, wherein the interest indicator is an advertisement responsive to the search query;
means to obtain an indication of interest in response to interaction with the interest indicator from the search response,
wherein the interest indication is a searcher selection; means to provide a form to obtain additional indication of interest in response to the interest indication by the searcher, wherein the form is structured to obtain identifying information;
means to obtain the additional interest indication from form entries, wherein the additional interest indication is a searcher selection, wherein the additional interest indication includes identifying information, wherein the identifying information includes a personal identifier, wherein the personal identifier includes contact information, wherein the contact information includes an email address, means to verify any obtained searcher interest information for validity;
means to store any of the searcher interest information; means to submit any of the searcher interest information for bidding; means to obtain bids from bidders interested in the searcher interest information;
means to determine candidate bids for bidding by comparing bid parameters to searcher interest information, wherein comparison is made on the basis of: types of interest information, level of detail of interest information, filtering criteria, and regional limitations; means to select at least one winning bid from the candidate bids, wherein candidate bids having highest values are selected;
means to provide the searcher interest information to at least one of the bidders whose bid was selected as a winning bid;
means to provide the searcher with ads from the winning bidder; and means to charge the winning bidder for the provision of the searcher interest information.

208. A system to bid on indications of interest, comprising:
means to obtain a search query from a searcher; means to search a database for advertisements responsive to the search query;
means to provide the searcher with a search response responsive to the search query, wherein the search response contains at least one interest indicator;
means to obtain an indication of interest in response to interaction with the interest indicator from the search response;
means to obtain bids from bidders interested in the searcher interest indication;
means to select at least one winning bid from the obtained candidate bids;
means to provide the searcher interest indication to at least one of the bidders whose bid was selected as a winning bid.

209. A system to bid on indications of interest, comprising:
means to obtain a search query from a searcher; means to search a database for advertisements responsive to the search query;
means to provide the searcher with a search response responsive to the search query, wherein the search response contains at least one interest indicator;
means to obtain an indication of interest in response to interaction with the interest indicator from the search response.

210-322. (canceled)

323. A system to bid on indications of interest, comprising:
means to obtain information from a prospective bidder specifying a desired type of consumer interest indication;
means to obtain information from a prospective bidder specifying a desired region; means to obtain information from a prospective bidder specifying filters;
means to obtain information from a prospective bidder specifying bid values;
means to submit all obtained information as a qualification request for consumer interest indication;
matching the request for consumer interest indication with submitted consumer interest indications; means to determine which of the matched requests for consumer interest indication will win a hid for the submitted consumer interest indication;
means to select winning bidders from the determined winning bids with highest values;
means to provide the consumer interest indication to the winning bidders.

324. A system to hid on indications of interest, comprising:
means to obtain information from a prospective bidder specifying a desired type of consumer interest indication;
means to obtain information from a prospective bidder specifying bid values;
means to submit the obtained information as a qualification request for consumer interest indication;
matching the request for consumer interest indication with submitted consumer interest indications;
means to determine which of the matched requests for consumer interest indication will win a hid for the submitted consumer interest indication; means to select winning bidders from the determined winning bids, wherein the winning bidders are selected from bidding criteria; means to provide the consumer interest indication to the winning bidders.

325-354. (canceled)

355. A system to generate a data structure in memory, comprising: means to generate instruction signals, wherein the signal states embody a data structure having interrelated data types for:
means to invoke a field for information from a prospective bidder specifying a desired type of consumer interest indication;
means to invoke a field for information from a prospective bidder specifying a desired region;
means to invoke a field for information from a prospective bidder specifying filters; means to invoke a field for information from a prospective bidder specifying bid values.

356. A system to generate a data structure in memory, comprising: means to generate instruction signals, wherein the signal states embody a data structure having interrelated data types for:
means to invoke a field for information from a prospective bidder specifying a desired type of consumer interest indication;
means to invoke a field for information from a prospective bidder specifying bid values.

357-369. (canceled)

370. A system to generate an interaction interface in memory, comprising: means to generate instruction signals, wherein the interaction interface is responsive to user and system event signals and wherein the instruction signals are issueable by a processor for:
means to invoke a widget to accept information from a prospective bidder specifying a desired type of consumer interest indication;
means to invoke a widget to accept information from a prospective bidder specifying a desired region;
means to invoke a widget to accept information from a prospective bidder specifying filters;
means to invoke a widget to accept information from a prospective bidder specifying bid values.

371. A system to generate an interaction interface in memory, comprising: means to generate instruction signals, wherein the interaction interface is responsive to user and system event signals and wherein the instruction signals are issueable by a processor for:
means to invoke a widget to accept information from a prospective bidder specifying a desired type of consumer interest indication;
means to invoke a widget to accept information from a prospective bidder specifying bid values.

372-384. (canceled)

385. A system to generate a data structure in memory, comprising: means to generate instruction signals, wherein the signal states embody a data structure having interrelated data types for:
means to invoke a field for information from a consumer specifying a desired type of consumer interest indication;
means to invoke a field for information from a consumer specifying a desired region;
means to invoke a field for information from a consumer specifying filters.

386. A system to generate a data structure in memory, comprising: means to generate instruction signals, wherein the signal states embody a data structure having interrelated data types for:
means to invoke a field for information from a consumer specifying a desired type of consumer interest indication.

387-396. (canceled)

397. A system to generate an interaction interface in memory, comprising:
means to generate instruction signals, wherein the interaction interface is responsive to user and system event signals and wherein the instruction signals are issueable by a processor for:
means to invoke a widget to accept information from a consumer specifying a desired type of consumer interest indication;
means to invoke a widget to accept information from a consumer specifying a desired region;
means to invoke a widget to accept information from a consumer specifying filters.

398. A system to generate an interaction interface in memory, comprising: means to generate instruction signals, wherein the interaction interface is responsive to user and system event signals and wherein the instruction signals are issueable by a processor for:
means to invoke a widget to accept information from a consumer specifying a desired type of consumer interest indication.

399-408. (canceled)

409. A system to bid on sales leads, comprising:
means to aggregate searches in articles of commerce, wherein searches for the articles of commerce are collected through a search facility from bid generators; means to acquire identifying information from the bid generators, wherein the identifying information may include: email addresses, name, address, telephone numbers, responses to and Web form queries;
means to generate a lead from the searches and associated acquired information;
means to accept bids for the leads from providers of articles of commerce matching the lead search requirements and identifying information; and
means to award the leads to winning bids.

410-412. (canceled)

413. A medium readable by a processor to bid on indications of interest, comprising:
instruction signals in the processor readable medium, wherein the instruction signals are issuable by the processor to:
obtain a search query from a searcher; find keywords in a search ontology with terms from the search query; search a database for advertisements responsive to the search query, wherein the search for advertisements uses both the search query and found keywords;
provide the searcher with a search response responsive to the search query; wherein the search response includes at least one invokeable indicator of interest that is invokeable by the searcher, wherein the interest indicator is an advertisement responsive to the search query;
obtain an indication of interest in response to interaction with the interest indicator from the search response, wherein the interest indication is a searcher selection;
provide a form to obtain additional indication of interest in response to the interest indication by the searcher, wherein the form is structured to obtain identifying information;
obtain the additional interest indication from form entries, wherein the additional interest indication is a searcher selection, wherein the additional interest indication includes identifying information, wherein the identifying information includes a personal identifier, wherein the personal identifier includes contact information, wherein the contact information includes an email address, verify any obtained searcher interest information for validity; store any of the searcher interest information;
submit any of the searcher interest information for bidding; obtain bids from bidders interested in the searcher interest information;
determine candidate bids for bidding by comparing bid parameters to searcher interest information, wherein comparison is made on the basis of: types of interest information, level of detail of interest information, filtering criteria, and regional limitations; select at least one winning bid from the candidate bids, wherein candidate bids having highest values are selected;
provide the searcher interest information to at least one of the bidders whose hid was selected as a winning bid; provide the searcher with ads from the winning bidder; and
charge the winning bidder for the provision of the searcher interest information.

414. A medium readable by a processor to bid on indications of interest, comprising:
instruction signals in the processor readable medium, wherein the instruction signals are issuable by the processor to:
obtain a search query from a searcher; search a database for advertisements responsive to the search query;
provide the searcher with a search response responsive to the search query, wherein the search response contains at least one interest indicator;
obtain an indication of interest in response to interaction with the interest indicator from the search response;
obtain bids from bidders interested in the searcher interest indication;
select at least one winning bid from the obtained candidate bids;
provide the searcher interest indication to at least one of the bidders whose bid was selected as a winning bid.

415. A medium readable by a processor to bid on indications of interest, comprising:
instruction signals in the processor readable medium, wherein the instruction signals are issuable by the processor to:
obtain a search query from a searcher; search a database for advertisements responsive to the search query;
provide the searcher with a search response responsive to the search query, wherein the search response contains at least one interest indicator;
obtain an indication of interest in response to interaction with the interest indicator from the search response.

416-528. (canceled)

529. A medium readable by a processor to bid on indications of interest, comprising:
instruction signals in the processor readable medium, wherein the instruction signals are issuable by the processor to:
obtain information from a prospective bidder specifying a desired type of consumer interest indication;
obtain information from a prospective bidder specifying a desired region;
obtain information from a prospective bidder specifying filters; obtain information from a prospective bidder specifying bid values;
submit all obtained information as a qualification request for consumer interest indication;
matching the request for consumer interest indication with submitted consumer interest indications;
determine which of the matched requests for consumer interest indication will win a bid for the submitted consumer interest indication;
select winning bidders from the determined winning bids with highest values;
provide the consumer interest indication to the winning bidders.

530. A medium readable by a processor to bid on indications of interest, comprising:
instruction signals in the processor readable medium, wherein the instruction signals are issuable by the processor to:
obtain information from a prospective bidder specifying a desired type of consumer interest indication;
obtain information from a prospective bidder specifying bid values;
submit the obtained information as a qualification request for consumer interest indication;
matching the request for consumer interest indication with submitted consumer interest indications;
determine which of the matched requests for consumer interest indication will win a bid for the submitted consumer interest indication; select winning bidders from the determined winning bids, wherein the winning bidders are selected from bidding criteria;
provide the consumer interest indication to the winning bidders.

531-560. (canceled)

561. A medium readable by a processor to generate a data structure in memory, comprising:
instruction signals in the processor readable medium, wherein the instruction signals are issuable by the processor to:
generate instruction signals, wherein the signal states embody a data structure having interrelated data types to:
invoke a field for information from a prospective bidder specifying a desired type of consumer interest indication;
invoke a field for information from a prospective bidder specifying a desired region;
invoke a field for information from a prospective bidder specifying filters;
invoke a field for information from a prospective bidder specifying bid values.

562. A medium readable by a processor to generate a data structure in memory, comprising:
instruction signals in the processor readable medium, wherein the instruction signals are issuable by the processor to:
generate instruction signals, wherein the signal states embody a data structure having interrelated data types to:
invoke a field for information from a prospective bidder specifying a desired type of consumer interest indication;
invoke a field for information from a prospective bidder specifying bid values.

563-575. (canceled)

576. A medium readable by a processor to generate an interaction interface in memory, comprising:
instruction signals in the processor readable medium, wherein the instruction signals are issuable by the processor to:
generate instruction signals, wherein the interaction interface is responsive to user and system event signals and wherein the instruction signals are issueable by a processor to:
invoke a widget to accept information from a prospective bidder specifying a desired type of consumer interest indication;
invoke a widget to accept information from a prospective bidder specifying a desired region;
invoke a widget to accept information from a prospective bidder specifying filters;
invoke a widget to accept information from a prospective bidder specifying bid values.

577. A medium readable by a processor to generate an interaction interface in memory, comprising:
instruction signals in the processor readable medium, wherein the instruction signals are issuable by the processor to:
generate instruction signals, wherein the interaction interface is responsive to user and system event signals and wherein the instruction signals are issueable by a processor to:
invoke a widget to accept information from a prospective bidder specifying a desired type of consumer interest indication;
invoke a widget to accept information from a prospective bidder specifying bid values.

578-590. (canceled)

591. A medium readable by a processor to generate a data structure in memory, comprising:
instruction signals in the processor readable medium, wherein the instruction signals are issuable by the processor to:
generate instruction signals, wherein the signal states embody a data structure having interrelated data types to:
invoke a field for information from a consumer specifying a desired type of consumer interest indication;
invoke a field for information from a consumer specifying a desired region;
invoke a field for information from a consumer specifying filters.

592. A medium readable by a processor to generate a data structure in memory, comprising:
instruction signals in the processor readable medium, wherein the instruction signals are issuable by the processor to:
generate instruction signals, wherein the signal states embody a data structure having interrelated data types to:
invoke a field for information from a consumer specifying a desired type of consumer interest indication.

593-602. (canceled)

603. A medium readable by a processor to generate an interaction interface in memory, comprising:
instruction signals in the processor readable medium, wherein the instruction signals are issuable by the processor to:
generate instruction signals, wherein the interaction interface is responsive to user and system event signals and wherein the instruction signals are issueable by a processor to:
invoke a widget to accept information from a consumer specifying a desired type of consume indication;
invoke a widget to accept information from a consumer specifying a desired region;
invoke a widget to accept information from a consumer specifying filters.

604. A medium readable by a processor to generate an interaction interface in memory, comprising:
instruction signals in the processor readable medium, wherein the instruction signals are issuable by the processor to:
generate instruction signals, wherein the interaction interface is responsive to user and system event signals and wherein the instruction signals are issueable by a processor to:
invoke a widget to accept information from a consumer specifying a desired type of consumer interest indication.

605-614. (canceled)

615. A medium readable by a processor to bid on sales leads, comprising:
instruction signals in the processor readable medium, wherein the instruction signals are issuable by the processor to:
aggregate searches in articles of commerce, wherein searches for the articles of commerce are collected through a search facility from bid generators;
acquire identifying information from the bid generators, wherein the identifying information may include: email addresses, name, address, telephone numbers, responses to and Web form queries; generate a lead from the searches and associated acquired information;
accept bids for the leads from providers of articles of commerce matching the lead search requirements and identifying information; and award the leads to winning bids.

616-618. (canceled)

619. An apparatus to bid on indications of interest, comprising:
a memory; a processor disposed in communication with said memory, and configured to issue a plurality of processing instructions stored in the memory, wherein the instructions issue signals to:
obtain a search query from a searcher;
find keywords in a search ontology with terms from the search query; search a database for advertisements responsive to the search query, wherein the search for advertisements uses both the search query and found keywords; provide the searcher with a search response responsive to the search query;
wherein the search response includes at least one invokeable indicator of interest that is invokeable by the searcher, wherein the interest indicator is an advertisement responsive to the search query;
obtain an indication of interest in response to interaction with the interest indicator from the search response, wherein the interest indication is a searcher selection;
provide a form to obtain additional indication of interest in response to the interest indication by the searcher, wherein the form is structured to obtain identifying information;
obtain the additional interest indication from form entries, wherein the additional interest indication is a searcher selection, wherein the additional interest indication includes identifying information, wherein the identifying information includes a personal identifier, wherein the personal identifier includes contact information, wherein the contact information includes an email address, verify any obtained searcher interest information for validity;
store any of the searcher interest information;
submit any of the searcher interest information for bidding;
obtain bids from bidders interested in the searcher interest information;
determine candidate bids for bidding by comparing bid parameters to searcher interest information, wherein comparison is made on the basis of: types of interest information, level of detail of interest information, filtering criteria, and regional limitations;
select at least one winning bid from the candidate bids, wherein candidate bids having highest values are selected; provide the searcher interest information to at least one of the bidders whose bid was selected as a winning bid;
provide the searcher with ads from the winning bidder; and charge the winning bidder for the provision of the searcher interest information.

620. An apparatus to bid on indications of interest, comprising:
a memory; a processor disposed in communication with said memory, and configured to issue a plurality of processing instructions stored in the memory, wherein the instructions issue signals to:
obtain a search query from a searcher;
search a database for advertisements responsive to the search query;
provide the searcher with a search response responsive to the search query, wherein the search response contains at least one interest indicator;
obtain an indication of interest in response to interaction with the interest indicator from the search response;
obtain bids from bidders interested in the searcher interest indication; select at least one winning bid from the obtained candidate bids;
provide the searcher interest indication to at least one of the bidders whose bid was selected as a winning bid.

621. An apparatus to bid on indications of interest, comprising:
a memory;
a processor disposed in communication with said memory, and configured to issue a plurality of processing instructions stored in the memory, wherein the instructions issue signals to:
obtain a search query from a searcher; search a database for advertisements responsive to the search query;
provide the searcher with a search response responsive to the search query, wherein the search response contains at least one interest indicator;
obtain an indication of interest in response to interaction with the interest indicator from the search response.

622-734. (canceled)

735. An apparatus to bid on indications of interest, comprising:
a memory;
a processor disposed in communication with said memory, and configured to issue a plurality of processing instructions stored in the memory, wherein the instructions issue signals to:
obtain information from a prospective bidder specifying a desired type of consumer interest indication;
obtain information from a prospective bidder specifying a desired region;
obtain information from a prospective bidder specifying filters; obtain information from a prospective bidder specifying bid values;
submit all obtained information as a qualification request for consumer interest indication;
matching the request for consumer interest indication with submitted consumer interest indications;
determine which of the matched requests for consumer interest indication will win a bid for the submitted consumer interest indication;
select winning bidders from the determined winning bids with highest values; provide the consumer interest indication to the winning bidders.

736. An apparatus to bid on indications of interest, comprising:
a memory;
a processor disposed in communication with said memory, and configured to issue a plurality of processing instructions stored in the memory, wherein the instructions issue signals to:
obtain information from a prospective bidder specifying a desired type of consumer interest indication;
obtain information from a prospective bidder specifying bid values;
submit the obtained information as a qualification request for consumer interest indication;
matching the request for consumer interest indication with submitted consumer interest indications;
determine which of the matched requests for consumer interest indication will win a bid for the submitted consumer interest indication;
select winning bidders from the determined winning bids, wherein the winning bidders are selected from bidding criteria; provide the consumer interest indication to the winning bidders.

737-766. (canceled)

767. An apparatus to generate a data structure in memory, comprising:
a memory;
a processor disposed in communication with said memory, and configured to issue a plurality of processing instructions stored in the memory, wherein the instructions issue signals to:
generate instruction signals, wherein the signal states embody a data structure having interrelated data types to:
invoke a field for information from a prospective bidder specifying a desired type of consumer interest indication;
invoke a field for information from a prospective bidder specifying a desired region;
invoke a field for information from a prospective bidder specifying filters;
invoke a field for information from a prospective bidder specifying bid values.

768. An apparatus to generate a data structure in memory, comprising:
a memory;
a processor disposed in communication with said memory, and configured to issue a plurality of processing instructions stored in the memory, wherein the instructions issue signals to:
generate instruction signals, wherein the signal states embody a data structure having interrelated data types to:
invoke a field for information from a prospective bidder specifying a desired type of consumer interest indication;
invoke a field for information from a prospective bidder specifying bid values.

769-781. (canceled)

782. An apparatus to generate an interaction interface in memory, comprising:
a memory;
a processor disposed in communication with said memory, and configured to issue a plurality of processing instructions stored in the memory, wherein the instructions issue signals to:
generate instruction signals, wherein the interaction interface is responsive to user and system event signals and wherein the instruction signals are issueable by a processor to:
invoke a widget to accept information from a prospective bidder specifying a desired type of consumer interest indication;
invoke a widget to accept information from a prospective bidder specifying a desired region;
invoke a widget to accept information from a prospective bidder specifying filters;
invoke a widget to accept information from a prospective bidder specifying bid values.

783. An apparatus to generate an interaction interface in memory, comprising:
a memory;
a processor disposed in communication with said memory, and configured to issue a plurality of processing instructions stored in the memory, wherein the instructions issue signals to:
generate instruction signals, wherein the interaction interface is responsive to user and system event signals and wherein the instruction signals are issueable by a processor to:
invoke a widget to accept information from a prospective bidder specifying a desired type of consumer interest indication;
invoke a widget to accept information from a prospective bidder specifying bid values.

784-796. (canceled)

797. An apparatus to generate a data structure in memory, comprising:
a memory;
a processor disposed in communication with said memory, and configured to issue a plurality of processing instructions stored in the memory, wherein the instructions issue signals to:
generate instruction signals, wherein the signal states embody a data structure having interrelated data types to:
invoke a field for information from a consumer specifying a desired type of consumer interest indication;
invoke a field for information from a consumer specifying a desired region; invoke a field for information from a consumer specifying filter.

798. An apparatus to generate a data structure in memory, comprising:
a memory;
a processor disposed in communication with said memory, and configured to issue a plurality of processing instructions stored in the memory, wherein the instructions issue signals to:
generate instruction signals, wherein, the signal states embody a data structure having interrelated data types to:
invoke a field for information from a consumer specifying a desired type of consumer interest indication.

799-808. (canceled)

809. An apparatus to generate an interaction interface in memory, comprising:
a memory;
a processor disposed in communication with said memory, and configured to issue a plurality of processing instructions stored in the memory, wherein the instructions issue signals to:
generate instruction signals, wherein the interaction interface is responsive to user and system event signals and wherein the instruction signals are issueable by a processor to:
invoke a widget to accept information from a consumer specifying a desired type of consumer interest indication;
invoke a widget to accept information from a consumer specifying a desired region;
invoke a widget to accept information from a consumer specifying filters.

810. An apparatus to generate an interaction interface in memory, comprising:
a memory;
a processor disposed in communication with said memory, and configured to issue a plurality of processing instructions stored in the memory, wherein the instructions issue signals to:
generate instruction signals, wherein the interaction interface is responsive to user and system event signals and wherein the instruction signals are issueable by a processor to:
invoke a widget to accept information from a consumer specifying a desired type of consumer interest indication.

811-820. (canceled)

821. An apparatus to bid on sales leads, comprising:
a memory;
a processor disposed in communication with said memory, and configured to issue a plurality of processing instructions stored in the memory, wherein the instructions issue signals to:
aggregate searches in articles of commerce, wherein searches for the articles of commerce are collected through a search facility from bid generators;
acquire identifying information from the bid generators, wherein the identifying information may include: email addresses, name, address, telephone numbers, responses to and Web form queries;
generate a lead from the searches and associated acquired information; accept bids for the leads from providers of articles of commerce matching the lead search requirements and identifying information; and
award the leads to winning bids.

822-824. (canceled)

825. A processor accessible medium having signal states, wherein the signal states embody a data structure having interrelated data types, comprising:
a field for information from a prospective bidder specifying a desired type of consumer interest indication; a field for information from a prospective bidder specifying a desired region; a field for information from a prospective bidder specifying filters; a field for information from a prospective bidder specifying hid values.

826. A processor accessible medium having signal states, wherein the signal states embody a data structure having interrelated data types, comprising:
a field for information from a prospective bidder specifying a desired type of consumer interest indication; a field for information from a prospective bidder specifying bid values.

827. The data structure of claim 826, further, comprising: a field for information from a prospective bidder specifying a desired region.

828. The data structure of claim 826, further, comprising: a field for information from a prospective bidder specifying filters.

829. The data structure of claim 826, wherein the region field may include country, province, state, postal code, demographic area, and metropolitan market area information.

830. The data structure of claim 826, wherein the consumer interest indication includes interest indication about a category.

831. The data structure of claim 826, wherein the consumer interest indication includes interest indication about a subcategory.

832. The data structure of claim 826, wherein the consumer interest indication includes interest indication about a goods and services.

833. The data structure of claim 826, wherein the consumer interest indication is a consumer selection.

834. The data structure of claim 826, wherein the interest indication includes filtering limitations.

835. The data structure of claim 834, wherein the filtering limitations are of a brand.

836. The data structure of claim 826, wherein the consumer interest indication includes identifying information.

837. The data structure of claim 826, wherein the bid values include bid amounts.

838. The data structure of claim 826, wherein the bid values include hid increments.

839. The data structure of claim 826, wherein the bid values include bid caps.

840. In memory, an interaction interface, comprising: instruction signals, wherein the interaction interface is responsive to user and system event signals and wherein the instruction signals are issueable by a processor to invoke: a widget to accept information from a prospective bidder specifying a desired type of consumer interest indication; a widget to accept information from a prospective bidder specifying a desired region; a widget to accept information from a prospective bidder specifying filters;
a widget to accept information from a prospective bidder specifying bid values.

841. In memory, an interaction interface, comprising: instruction signals, wherein the interaction interface is responsive to user and system event signals and wherein the instruction signals are issueable by a processor to invoke: a widget to accept information from a prospective bidder specifying a desired type of consumer interest indication; a widget to accept information from a prospective bidder specifying bid values.

842. The interface of claim 841, further, comprising: a widget to accept information from a prospective bidder specifying a desired region.

843. The interface of claim 841, further, comprising: a widget to accept information from a prospective bidder specifying filters.

844. The interface of claim 841, wherein the region field may include country, province, state, postal code, demographic area, and metropolitan market area information.

845. The interface of claim 841, wherein the consumer interest indication includes interest indication about a category.

846. The interface of claim 841, wherein the consumer interest indication includes interest indication about a subcategory.

847. The interface of claim 841, wherein the consumer interest indication includes interest indication about a goods and services.

848. The interface of claim 841, wherein the consumer interest indication is a consumer selection.

849. The interface of claim 841, wherein the interest indication includes filtering limitations.

850. The interface of claim 849, wherein the filtering limitations are of a brand.

851. The interface of claim 841, wherein the consumer interest indication includes identifying information.

852. The interface of claim 841, wherein the bid values include bid amounts.

853. The interface of claim 841, wherein the hid values include bid increments.

854. The interface of claim 841 wherein the bid values include bid caps.

855. A processor accessible medium having signal states, wherein the signal states embody a data structure having interrelated data types, comprising: a field for information from a consumer specifying a desired type of consumer interest indication; a field for information from a consumer specifying a desired region; a field for information from a consumer specifying filters.

856. A processor accessible medium having signal states, wherein the signal states embody a data structure having interrelated data types, comprising: a field for information from a consumer specifying a desired type of consumer interest indication.

857. The data structure of claim 856, further, comprising: a field for information from a consumer specifying a desired region.

858. The data structure of claim 856, further, comprising: a field for information from a consumer specifying filters.

859. The data structure of claim 856, wherein the region field may include country, province, state, postal code, demographic area, and metropolitan market area information.

860. The data structure of claim 856, wherein the consumer interest indication includes interest indication about a category.

861. The data structure of claim 856, wherein the consumer interest indication includes interest indication about a subcategory.

862. The data structure of claim 856, wherein the consumer interest indication includes interest indication about a goods and services.

863. The data structure of claim 856, wherein the consumer interest indication is a consumer selection.

864. The data structure of claim 856 wherein the interest indication includes filtering limitations.

865. The data structure of claim 864, wherein the filtering limitations are of a brand.

866. The data structure of claim 856, wherein the consumer interest indication includes identifying information.

867. In memory, an interaction interface, comprising: instruction signals, wherein the interaction interface is responsive to user and system event signals and wherein the instruction signals are issueable by a processor to invoke:
a widget to accept information from a consumer specifying a desired type of consumer interest indication;
a widget to accept information from a consumer specifying a desired region; a widget to accept information from a consumer specifying filters.

868. In memory, an interaction interface, comprising: instruction signals, wherein the interaction interface is responsive to user and system event signals and wherein the instruction signals are issueable by a processor to invoke: a widget to accept information from a consumer specifying a desired type of consumer interest indication.

869. The interface of claim 868, further, comprising: a widget to accept information from a consumer specifying a desired region.

870. The interface of claim 868, further, comprising: a widget to accept information from a consumer specifying filters.

871. The interface of claim 868, wherein the region field may include country, province, state, postal code, demographic area, and metropolitan market area information.

872. The interface of claim 868, wherein the consumer interest indication includes interest indication about a category.

873. The interface of claim 868, wherein the consumer interest indication includes interest indication about a subcategory.

874. The interface of claim 868, wherein the consumer interest indication includes interest indication about a goods and services.

875. The interface of claim 868, wherein the consumer interest indication is a consumer selection.

876. The interface of claim 868, wherein the interest indication includes filtering limitations.

877. The interface of claim 876, wherein the filtering limitations are of a brand.

878. The interface of claim 868, wherein the consumer interest indication includes identifying information.
